(19) United States
(12) Patent Application Publication
(10) Pub. No.: US 2026/0063872 A1
(43) Pub. Date: Mar. 5, 2026

(54) OPTICAL IMAGING LENS ASSEMBLY

(71) Applicant: ZHEJIANG SUNNY OPTICS CO., LTD., Yuyao City (CN)

(72) Inventors: Wanli DOU, Yuyao City (CN); Min Yang, Yuyao City (CN); Weifang LI, Yuyao City (CN); Litong SONG, Yuyao City (CN)

(73) Assignee: ZHEJIANG SUNNY OPTICS CO., LTD., Yuyao City (CN)

(21) Appl. No.: 19/284,345

(22) Filed: Jul. 29, 2025

(30) Foreign Application Priority Data
Sep. 2, 2024 (CN) 202411224657.6

(51) Int. Cl. G02B 13/00; G02B 7/02; G02B 9/62

(52) U.S. Cl. CPC G02B 13/0045; G02B 7/021; G02B 9/62

(57) ABSTRACT

Disclosed is an optical imaging lens assembly. The optical imaging lens assembly includes: a lens barrel, a lens group, and a supporting element group disposed in the lens barrel. The lens group includes: a first lens, a second lens, a third lens, a fourth lens, a fifth lens and a sixth lens. The supporting element group comprises a fifth supporting element disposed on the image side of the fifth lens and in contact with the image-side surface of the fifth lens. The optical imaging lens assembly satisfies: 2.25<CT5/CT6<3.05; 6.25<(d0m−d5s)/CT6<8.7, where CT5 is the central thickness of the fifth lens on the optical axis, CT6 is the central thickness of the sixth lens on the optical axis, d0m is the inner diameter of the image-side end surface of the lens barrel, and d5s is the inner diameter of the object-side surface of the fifth supporting element.

### CROSS-REFERENCE TO RELATED APPLICATIONS

The present application claims priority to and benefit of China patent application No. 202411224657.6, filed on Sep. 2, 2024, which is hereby incorporated by reference in its entirety.

### TECHNICAL FIELD

The present application relates to the field of optical components, and more specifically, to an optical imaging lens assembly.

### BACKGROUND

With the improvement of people's quality of life, the demand for various portable communication devices has also increased, and smart wearable devices have rapidly become popular. Various smart wearable devices are used in high-temperature or cold environments, which requires smart devices to adapt to different environments and maintain stable imaging quality.

For the lens assembly of smart wearable devices, especially for small wrist-mounted portable video communication devices, it is required not only that their volume be small to fit the space of small devices, but also that they have impact resistance in the application environment and meet the high imaging quality requirements in outdoor environments. However, existing lens assemblies in related art suffer from reflection problems between lenses, which can easily lead to excessive stray light, or lens assemblies with less stray light cannot guarantee the required image height, and such lens assemblies cannot meet the high imaging quality requirements for lens assemblies.

### SUMMARY

A first aspect of the present application provides an optical imaging lens assembly, which comprises: a lens barrel, and a lens group and a supporting element group disposed in the lens barrel, wherein, the lens group sequentially comprises, along an optical axis from an object side to an image side: a first lens having negative refractive power, its object-side surface being a convex surface and its image-side surface being a concave surface; a second lens having refractive power, its object-side surface being a concave surface and its image-side surface being a convex surface; a third lens having positive refractive power, its object-side surface being a convex surface and its image-side surface being a convex surface; a fourth lens having negative refractive power, its image-side surface being a concave surface; a fifth lens having positive refractive power, its image-side surface being a convex surface; and a sixth lens having negative refractive power, its object-side surface being a convex surface and its image-side surface being a concave surface; the supporting element group comprises a fifth supporting element disposed on the image side of the fifth lens and in contact with the image-side surface of the fifth lens. The optical imaging lens assembly satisfies: 2.25<CT5/CT6<3.05; 6.25<(d0m−d5s)/CT6<8.7, wherein CT5 is the central thickness of the fifth lens on the optical axis, CT6 is the central thickness of the sixth lens on the optical axis, d0m is the inner diameter of the image-side end surface of the lens barrel, and d5s is the inner diameter of the object-side surface of the fifth supporting element.

Lens assemblies in related art often cannot simultaneously achieve high image height and low stray light. However, in the present application, the lens group sequentially comprises, along the optical axis from the object side to the image side, a first lens having negative refractive power, its object-side surface being a convex surface and its image-side surface being a concave surface; a second lens having refractive power, its object-side surface being a concave surface and its image-side surface being a convex surface; a third lens having positive refractive power, its object-side surface being a convex surface and its image-side surface being a convex surface; a fourth lens having negative refractive power, its image-side surface being a concave surface; a fifth lens having positive refractive power, its image-side surface being a convex surface; and a sixth lens having negative refractive power, its object-side surface being a convex surface and its image-side surface being a concave surface, and the optical imaging lens assembly satisfies 2.25<CT5/CT6<3.05. The above optical imaging lens assembly structure has high image quality, but between the fifth lens and the sixth lens, the light path can generate more reflections when passing through, causing the problem of excessive stray light. The optical imaging lens assembly in this application sets a fifth supporting element on the image side of the fifth lens and satisfies 6.25< (d0m−d5s)/CT6<8.7, so that the stray light path can be blocked when passing through the fifth supporting element, and is controlled within a reasonable range, effectively controlling the reflection problem between the sixth lens and the fifth lens. Based on this, the optical imaging lens assembly provided by the embodiments of the present application can achieve both high image height and low stray light, meeting the market's high imaging quality requirements for lens assemblies, especially for lens assemblies of smart wearable devices.

Another aspect of the present application provides an optical imaging lens assembly, which comprises: a lens barrel, and a lens group and a supporting element group disposed in the lens barrel, wherein, the lens group sequentially comprises, along the optical axis from the object side to the image side: a first lens having negative refractive power, its object-side surface being a convex surface and its image-side surface being a concave surface; a second lens having refractive power, its object-side surface being a concave surface and its image-side surface being a convex surface; a third lens having positive refractive power, its object-side surface being a convex surface and its image-side surface being a convex surface; a fourth lens having negative refractive power, its image-side surface being a concave surface; a fifth lens having positive refractive power, its image-side surface being a convex surface; and a sixth lens having negative refractive power, its object-side surface being a convex surface and its image-side surface being a concave surface; the supporting element group comprises a first supporting element disposed on the image side of the first lens and in contact with the image-side surface of the first lens, and a second supporting element disposed on the image side of the second lens and in contact with the image-side surface of the second lens and the inner wall of the lens barrel. The optical imaging lens assembly satisfies: 2<TD/f<2.6; −2.1<R3/f<−1; −8.8<R3/EP12<−4.38; 10≤d2s/T23<43.2, wherein TD is the distance along the optical axis from the object-side surface of the first lens to the image-side surface of the sixth lens, f is the effective focal length of the optical imaging lens assembly, R3 is the radius of curvature of the object-side surface of the second lens, EP12 is the axial distance from the image-side surface of the first supporting element to the object-side surface of the second supporting element, d2s is the inner diameter of the object-side surface of the second supporting element, and T23 is the distance along the optical axis from the image-side surface of the second lens to the object-side surface of the third lens.

Still another aspect of the present application provides an optical imaging lens assembly, which comprises: a lens barrel, and a lens group and a supporting element group disposed in the lens barrel, wherein, the lens group sequentially comprises, along the optical axis from the object side to the image side: a first lens having negative refractive power, its object-side surface being a convex surface and its image-side surface being a concave surface; a second lens having refractive power, its object-side surface being a concave surface and its image-side surface being a convex surface; a third lens having positive refractive power, its object-side surface being a convex surface and its image-side surface being a convex surface; a fourth lens having negative refractive power, its image-side surface being a concave surface; a fifth lens having positive refractive power, its image-side surface being a convex surface; and a sixth lens having negative refractive power, its object-side surface being a convex surface and its image-side surface being a concave surface. The optical imaging lens assembly satisfies: 0.45< (D0m−D0s)/TD<0.6; 0.95<L/TD<1.15, wherein D0m is the outer diameter of the image-side end surface of the lens barrel, D0s is the outer diameter of the object-side end surface of the lens barrel, TD is the distance along the optical axis from the object-side surface of the first lens to the image-side surface of the sixth lens, and L is the distance along the optical axis from the object-side end surface to the image-side end surface of the lens barrel.

In an embodiment, the optical imaging lens assembly satisfies: 2.1<CT3/CT4<3.2; 2.2<(CT3+CT5)/L<2.75, wherein CT3 is the central thickness of the third lens on the optical axis, CT4 is the central thickness of the fourth lens on the optical axis, CT5 is the central thickness of the fifth lens on the optical axis, and L is the distance along the optical axis from the object-side end surface to the image-side end surface of the lens barrel.

In an embodiment, the optical imaging lens assembly satisfies: 0.45< (D0m−D0s)/TD<0.6; 0.95<L/TD<1.15, wherein D0m is the outer diameter of the image-side end surface of the lens barrel, D0s is the outer diameter of the object-side end surface of the lens barrel, TD is the distance along the optical axis from the object-side surface of the first lens to the image-side surface of the sixth lens, and L is the distance along the optical axis from the object-side end surface to the image-side end surface of the lens barrel.

In an embodiment, the optical imaging lens assembly satisfies: 1.7< (d0m−d5m)/EP50m<2.6, wherein d0m is the inner diameter of the image-side end surface of the lens barrel, d5m is the inner diameter of the object-side surface of the fifth supporting element, and EP50m is the distance along the optical axis from the fifth supporting element to the image-side end surface of the lens barrel.

In an embodiment, the supporting element group further comprises a fourth supporting element disposed on the image side of the fourth lens and in contact with the image-side surface of the fourth lens, and the optical imaging lens assembly satisfies: −2.4<CT5/SAG52<−1.73; 0.45<EP45/CT5<0.65, wherein CT5 is the central thickness of the fifth lens on the optical axis, SAG52 is the axial distance between the intersection point of the image-side surface of the fifth lens and the optical axis and the effective radius vertex of the image-side surface of the fifth lens, and EP45 is the distance along the optical axis from the image-side surface of the fourth supporting element to the object-side surface of the fifth supporting element.

In an embodiment, the distance along the optical axis from the image-side surface of the first lens to the object-side surface of the second lens is greater than the distance along the optical axis between any other two adjacent lenses, the supporting element group further comprises a first supporting element disposed on the image side of the first lens and in contact with the image-side surface of the first lens, and a second supporting element disposed on the image side of the second lens and in contact with the image-side surface of the second lens and the inner wall of the lens barrel, and the optical imaging lens assembly satisfies: 0.7<CT1/ET1≤1.3; 0.4<EP01/(CT1+T12)<1.25, wherein CT1 is the central thickness of the first lens on the optical axis, ET1 is the edge thickness of the first lens in the effective optical region, EP01 is the distance along the optical axis from the object-side end surface of the lens barrel to the object-side surface of the first supporting element, and T12 is the distance along the optical axis from the image-side surface of the first lens to the object-side surface of the second lens.

In an embodiment, the supporting element group further comprises a second supporting element disposed on the image side of the second lens and in contact with the image-side surface of the second lens and the inner wall of the lens barrel, and the optical imaging lens assembly satisfies: 0.35< (d5s−d2m)/Tr5r10≤0.7, wherein d5s is the inner diameter of the object-side surface of the fifth supporting element, d2m is the inner diameter of the image-side surface of the second supporting element, and Tr5r10 is the distance along the optical axis from the object-side surface of the third lens to the image-side surface of the fifth lens.

In an embodiment, the supporting element group further comprises a second supporting element disposed on the image side of the second lens and in contact with the image-side surface of the second lens and the inner wall of the lens barrel, and a third supporting element disposed on the image side of the third lens and in contact with the image-side surface of the third lens, and the optical imaging lens assembly satisfies: −1.1<R6/f3<−0.65; −9.47<SAG32/SAG31<−2.85; 1.45<CT3/EP23<2.75, wherein R6 is the radius of curvature of the image-side surface of the third lens, f3 is the effective focal length of the third lens, SAG32 is the axial distance between the intersection point of the image-side surface of the third lens and the optical axis and the effective radius vertex of the image-side surface of the third lens, SAG31 is the axial distance between the intersection point of the object-side surface of the third lens and the optical axis and the effective radius vertex of the object-side surface of the third lens, CT3 is the central thickness of the third lens on the optical axis, and EP23 is the distance along the optical axis from the image-side surface of the second supporting element to the object-side surface of the third supporting element.

In an embodiment, the absolute value of the effective focal length of the third lens is less than the absolute value of the effective focal length of other lenses, the supporting element group further comprises a third supporting element disposed on the image side of the third lens and in contact with the image-side surface of the third lens, and the optical imaging lens assembly satisfies: 0.75<f3/f<1.05; 0.35<d3s/D3s<0.75, wherein f3 is the effective focal length of the third lens, f is the effective focal length of the optical imaging lens assembly, d3s is the inner diameter of the object-side surface of the third supporting element, and D3s is the outer diameter of the object-side surface of the third supporting element.

In an embodiment, the supporting element group further comprises a fourth supporting element disposed on the image side of the fourth lens and in contact with the image-side surface of the fourth lens, and the optical imaging lens assembly satisfies: 0<SAG51/CT5<0.2; 0.7<d4m/f5<1.3, wherein SAG51 is the axial distance between the intersection point of the object-side surface of the fifth lens and the optical axis and the effective radius vertex of the object-side surface of the fifth lens, CT5 is the central thickness of the fifth lens on the optical axis, d4m is the inner diameter of the image-side surface of the fourth supporting element, and f5 is the effective focal length of the fifth lens.

In an embodiment, the supporting element group further comprises a third supporting element disposed on the image side of the third lens and in contact with the image-side surface of the third lens, and a fourth supporting element disposed on the image side of the fourth lens and in contact with the image-side surface of the fourth lens, and the optical imaging lens assembly satisfies: 0.1<T34/CT4<0.55; 0.45<(D4s−D3s)/(T34+CT4+T45)<1.38, wherein T34 is the distance along the optical axis from the image-side surface of the third lens to the object-side surface of the fourth lens, CT4 is the central thickness of the fourth lens on the optical axis, T45 is the distance along the optical axis from the image-side surface of the fourth lens to the object-side surface of the fifth lens, D4s is the outer diameter of the object-side surface of the fourth supporting element, and D3s is the outer diameter of the object-side surface of the third supporting element.

In an embodiment, the supporting element group further comprises a fourth supporting element disposed on the image side of the fourth lens and in contact with the image-side surface of the fourth lens, the fourth supporting element and the fifth supporting element are in contact with the inner wall of the lens barrel, and the inner wall of the lens barrel has a transverse step between the locations where the fourth supporting element and the fifth supporting element contact the inner wall of the lens barrel, and the optical imaging lens assembly satisfies: 6.54<d5s/T56<76.1; 0.75<(D5m−D4m)/EP45<2.1, wherein d5s is the inner diameter of the object-side surface of the fifth supporting element, T56 is the distance along the optical axis from the image-side surface of the fifth lens to the object-side surface of the sixth lens, D5m is the outer diameter of the image-side surface of the fifth supporting element, D4m is the outer diameter of the image-side surface of the fourth supporting element, and EP45 is the distance along the optical axis from the image-side surface of the fourth supporting element to the object-side surface of the fifth supporting element.

In an embodiment, the optical imaging lens assembly satisfies: 0.4≤(D5m−D4m)/(D0m−d0m)<0.95, wherein D5m is the outer diameter of the image-side surface of the fifth supporting element, D4m is the outer diameter of the image-side surface of the fourth supporting element, D0m is the outer diameter of the image-side end surface of the lens barrel, and d0m is the inner diameter of the image-side end surface of the lens barrel.

In an embodiment, the supporting element group further comprises a first supporting element disposed on the image side of the first lens and in contact with the image-side surface of the first lens, and the optical imaging lens assembly satisfies: 1.33<tan (FOV/2)<1.56; −2.7<f1/f<−1.9; 3.6<(d0s−d1s)/CT1<6.45, wherein FOV is the maximum field angle of the optical imaging lens assembly, f1 is the effective focal length of the first lens, f is the effective focal length of the optical imaging lens assembly, dos is the inner diameter of the object-side end surface of the lens barrel, d1s is the inner diameter of the object-side surface of the first supporting element, and CT1 is the central thickness of the first lens on the optical axis.

In an embodiment, the supporting element group further comprises a third supporting element disposed on the image side of the third lens and in contact with the image-side surface of the third lens, and a fourth supporting element disposed on the image side of the fourth lens and in contact with the image-side surface of the fourth lens, and the optical imaging lens assembly satisfies: at least 2 lenses have a refractive index greater than 1.6, wherein the refractive index of the fourth lens is greater than 1.6; and 0.5<ET4/(CP3+EP34+CP4)<0.7, wherein ET4 is the edge thickness of the fourth lens in the effective optical region, CP3 is the distance along the optical axis from the object-side surface to the image-side surface of the third supporting element, EP34 is the distance along the optical axis from the image-side surface of the third supporting element to the object-side surface of the fourth supporting element, and CP4 is the distance along the optical axis from the object-side surface to the image-side surface of the fourth supporting element.

### BRIEF DESCRIPTION OF THE DRAWINGS

Other features, objectives, and advantages of the present application will become more apparent by reading the detailed description of non-limiting embodiments with reference to the following drawings:

FIG. 1 shows a structural arrangement diagram and a schematic diagram of some parameters of an optical imaging lens assembly according to an embodiment of the present application;

FIG. 2A shows a schematic structural diagram of an optical imaging lens assembly according to an embodiment of the present application satisfying CT5/CT6=2.27 and (d0m−d5s)/CT6=10.6; FIG. 2B shows a schematic diagram of stray light of the optical imaging lens assembly of FIG. 2A; FIG. 2C shows a schematic diagram of actual captured stray light of the optical imaging lens assembly of FIG. 2A;

FIG. 3A shows a schematic structural diagram of an optical imaging lens assembly according to an embodiment of the present application satisfying CT5/CT6=2.27 and (d0m−d5s)/CT6-6.3; FIG. 3B shows a schematic diagram of stray light of the optical imaging lens assembly of FIG. 3A; FIG. 3C shows a schematic diagram of actual captured stray light of the optical imaging lens assembly of FIG. 3A;

FIG. 4A shows a schematic structural diagram of an optical imaging lens assembly according to an embodiment of the present application satisfying CT5/CT6=2.27 and (d0m−d5s)/CT6=4.6, FIG. 4B shows a partially enlarged schematic diagram of portion J of the optical imaging lens assembly of FIG. 4A, and FIG. 4C shows a schematic diagram of top stray light of the optical imaging lens assembly of FIG. 4A, where M represents stray light, N represents newly added top stray light, and J represents the top partial area of the optical imaging lens assembly;

FIG. 5A shows a schematic structural diagram of an optical imaging lens assembly according to Embodiment 1 of the present application;

FIG. 5B shows a schematic structural diagram of an optical imaging lens assembly according to Embodiment 2 of the present application;

FIGS. 6A to 6D respectively show schematic diagrams of longitudinal aberration curves, astigmatism curves, distortion curves, and lateral color curves of the optical imaging lens assemblies according to Embodiments 1 and 2 of the present application;

FIG. 7A shows a schematic structural diagram of an optical imaging lens assembly according to Embodiment 3 of the present application;

FIG. 7B shows a schematic structural diagram of an optical imaging lens assembly according to Embodiment 4 of the present application;

FIGS. 8A to 8D respectively show schematic diagrams of longitudinal aberration curves, astigmatism curves, distortion curves, and lateral color curves of the optical imaging lens assemblies according to Embodiments 3 and 4 of the present application;

FIG. 9A shows a schematic structural diagram of an optical imaging lens assembly according to Embodiment 5 of the present application;

FIG. 9B shows a schematic structural diagram of an optical imaging lens assembly according to Embodiment 6 of the present application;

FIGS. 10A to 10D respectively show schematic diagrams of longitudinal aberration curves, astigmatism curves, distortion curves, and lateral color curves of the optical imaging lens assemblies according to Embodiments 5 and 6 of the present application;

FIG. 11A shows a schematic structural diagram of an optical imaging lens assembly according to Embodiment 7 of the present application;

FIG. 11B shows a schematic structural diagram of an optical imaging lens assembly according to Embodiment 8 of the present application; and

FIGS. 12A to 12D respectively show schematic diagrams of longitudinal aberration curves, astigmatism curves, distortion curves, and lateral color curves of the optical imaging lens assemblies according to Embodiments 7 and 8 of the present application.

### DETAILED DESCRIPTION OF EMBODIMENTS

To better understand the present application, various aspects of the present application will be described in more detail with reference to the accompanying drawings. It should be understood that these detailed descriptions are merely descriptions of exemplary embodiments of the present application and are not intended to limit the scope of the present application in any way. Throughout the specification, like reference numerals refer to like elements. The expression “and/or” comprises any and all combinations of one or more of the associated listed items.

It should be noted that in this specification, expressions such as “first,” “second,” “third,” etc., are used only to distinguish one feature from another feature, and do not indicate any limitation on the features. Therefore, without departing from the teachings of the present application, a first lens discussed below may also be referred to as a second lens or a third lens.

In the drawings, for ease of illustration, the thickness, size, and shape of the lenses have been slightly exaggerated. Specifically, the shapes of spherical or aspherical surfaces shown in the drawings are shown by way of example. That is, the shapes of spherical or aspherical surfaces are not limited to the shapes of spherical or aspherical surfaces shown in the drawings. The drawings are for illustration only and are not strictly to scale.

Herein, the paraxial region refers to the region near the optical axis. If the lens surface is convex and its position is not defined, it means that the lens surface is convex at least in the paraxial region; if the lens surface is concave and its position is not defined, it means that the lens surface is concave at least in the paraxial region. The surface of each lens close to the object to be photographed is called the object-side surface of the lens, and the surface of each lens close to the imaging surface is called the image-side surface of the lens.

It should also be understood that the terms “comprising,” “including,” “having,” “containing,” and/or “containing” when used in this specification indicate the presence of the stated features, elements, and/or components, but do not exclude the presence or addition of one or more other features, elements, components, and/or combinations thereof. Furthermore, when an expression such as “at least one of . . . ” appears after a list of listed features, it modifies the entire list of listed features, and not individual elements in the list. Furthermore, when describing embodiments of the present application, “may” is used to indicate “one or more embodiments of the present application.” And, the term “exemplary” is intended to mean an example or illustration.

Unless otherwise defined, all terms (including technical and scientific terms) used herein have the same meaning as commonly understood by one of ordinary skill in the art to which this application belongs. It should also be understood that terms (e.g., terms defined in commonly used dictionaries) should be interpreted as having meanings consistent with their meanings in the context of the relevant art, and will not be interpreted in an idealized or overly formal sense unless expressly so defined herein.

It should be noted that, without conflict, the embodiments and features in the embodiments of the present application can be combined with each other. The following embodiments only express several embodiments of the present application, and their descriptions are more specific and detailed, but this should not be understood as limiting the scope of the patent of the present application. It should be pointed out that for those skilled in the art, several deformations and improvements can be made without departing from the concept of the present application, which all fall within the protection scope of the present application. For example, the lens group, lens barrel, and supporting elements in various embodiments of the present application can be arbitrarily combined, and are not limited to the lens group in one embodiment only being combined with the lens barrel, supporting elements, and the like in that embodiment.

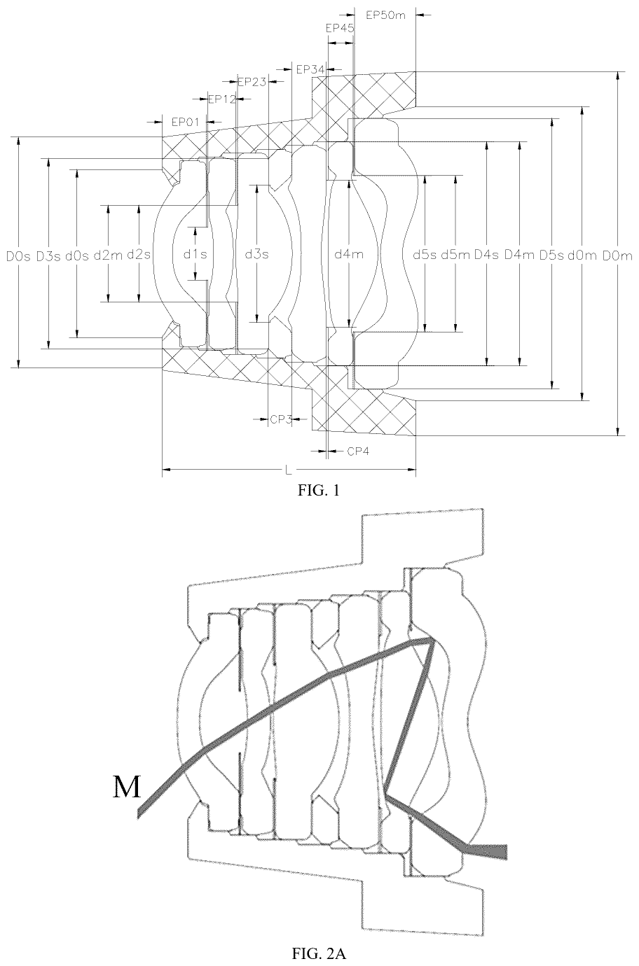

The present application will now be described in detail with reference to the accompanying drawings and in conjunction with embodiments. FIG. 1 shows a structural arrangement diagram and a schematic diagram of some parameters of an optical imaging lens assembly according to an embodiment of the present application. As shown in FIG. 1, an optical imaging lens assembly according to an exemplary embodiment of the present application comprises a lens barrel and a lens group and a supporting element group disposed in the lens barrel. The lens group may comprise six lenses having refractive power, which are a first lens, a second lens, a third lens, a fourth lens, a fifth lens, and a sixth lens. These six lenses are arranged sequentially along the optical axis from the object side to the image side. There may be a separation distance between any two adjacent lenses from the first lens to the sixth lens.

In an exemplary embodiment, the first lens may have negative refractive power, its object-side surface may be a convex surface, and its image-side surface may be a concave surface.

In an exemplary embodiment, the second lens may have positive or negative refractive power, its object-side surface may be a concave surface, and its image-side surface may be a convex surface.

In an exemplary embodiment, the third lens may have positive refractive power, its object-side surface may be a convex surface, and its image-side surface may be a convex surface.

In an exemplary embodiment, the fourth lens may have negative refractive power, and its image-side surface may be a concave surface.

In an exemplary embodiment, the fifth lens may have positive refractive power, and its image-side surface may be a convex surface.

In an exemplary embodiment, the sixth lens may have negative refractive power, its object-side surface may be a convex surface, and its image-side surface may be a concave surface.

In an exemplary embodiment, the supporting element group of the optical imaging lens assembly may comprise at least one of a first supporting element, a second supporting element, a third supporting element, a fourth supporting element, and a fifth supporting element. The first supporting element is disposed on the image side of the first lens and is in contact with the image-side surface of the first lens. The second supporting element is disposed on the image side of the second lens and is in contact with the image-side surface of the second lens. The third supporting element is disposed on the image side of the third lens and is in contact with the image-side surface of the third lens. The fourth supporting element is disposed on the image side of the fourth lens and is in contact with the image-side surface of the fourth lens. The fifth supporting element is disposed on the image side of the fifth lens and is in contact with the image-side surface of the fifth lens. Furthermore, at least one of the first supporting element, the second supporting element, the third supporting element, the fourth supporting element, and the fifth supporting element may be in contact with the inner wall of the lens barrel. It should be understood that the present application does not specifically limit the number of supporting elements; any number of supporting elements can be comprised between any two lenses, and the entire optical imaging lens assembly can also comprise any number of supporting elements. Supporting elements help the optical imaging lens assembly to block excess refracted and reflected light paths, reducing the generation of stray light and ghosting. Adding auxiliary support between the supporting elements and the lens barrel helps to improve problems such as poor assembly stability and low performance yield caused by large steps between lenses.

Those skilled in the art should understand that some parameters of lenses commonly used in the art (e.g., the central thickness CT1 of the first lens on the optical axis) are not shown in FIG. 1. FIG. 1 only exemplarily shows some parameters of the lens barrel and supporting elements of one optical imaging lens assembly of the present application to facilitate a better understanding of the present application. As shown in FIG. 1, EP01 represents the distance along the optical axis from the object-side end surface of the lens barrel to the object-side surface of the first supporting element, CP1 represents the maximum thickness of the first supporting element along the optical axis direction, CP2 represents the maximum thickness of the second supporting element along the optical axis direction, EP50m represents the distance along the optical axis from the fifth supporting element to the image-side end surface of the lens barrel, EP45 represents the distance along the optical axis from the image-side surface of the fourth supporting element to the object-side surface of the fifth supporting element, EP23 represents the distance along the optical axis from the image-side surface of the second supporting element to the object-side surface of the third supporting element, EP34 represents the distance along the optical axis from the image-side surface of the third supporting element to the object-side surface of the fourth supporting element, L represents the distance along the optical axis from the object-side end surface to the image-side end surface of the lens barrel, CP3 represents the distance along the optical axis from the object-side surface to the image-side surface of the third supporting element, CP4 represents the distance along the optical axis from the object-side surface to the image-side surface of the fourth supporting element, D0s represents the outer diameter of the object-side end surface of the lens barrel, D3s represents the outer diameter of the object-side surface of the third supporting element, dos represents the inner diameter of the object-side end surface of the lens barrel, d2m represents the inner diameter of the image-side surface of the second supporting element, d1s represents the inner diameter of the object-side surface of the first supporting element, d3s represents the inner diameter of the object-side surface of the third supporting element, d4m represents the inner diameter of the image-side surface of the fourth supporting element, d5s represents the inner diameter of the object-side surface of the fifth supporting element, d5m represents the inner diameter of the object-side surface of the fifth supporting element, D4s represents the outer diameter of the object-side surface of the fourth supporting element, D4m represents the outer diameter of the image-side surface of the fourth supporting element, d0m represents the inner diameter of the image-side end surface of the lens barrel, and D0m represents the outer diameter of the image-side end surface of the lens barrel.

In an exemplary embodiment, the optical imaging lens assembly satisfies: 2.25<CT5/CT6<3.05; 6.25<(d0m−d5s)/CT6<8.7, wherein CT5 is the central thickness of the fifth lens on the optical axis, CT6 is the central thickness of the sixth lens on the optical axis, d0m is the inner diameter of the image-side end surface of the lens barrel, and d5s is the inner diameter of the object-side surface of the fifth supporting element. Lens assemblies in related art often cannot simultaneously achieve high image height and low stray light. However, in the present application, a lens group sequentially comprises, along the optical axis from the object side to the image side, a first lens having negative refractive power, its object-side surface being a convex surface and its image-side surface being a concave surface; a second lens having refractive power, its object-side surface being a concave surface and its image-side surface being a convex surface; a third lens having positive refractive power, its object-side surface being a convex surface and its image-side surface being a convex surface; a fourth lens having negative refractive power, its image-side surface being a concave surface; a fifth lens having positive refractive power, its image-side surface being a convex surface; and a sixth lens having negative refractive power, its object-side surface being a convex surface and its image-side surface being a concave surface, and the optical imaging lens assembly satisfies 2.25<CT5/CT6<3.05. The above optical imaging lens assembly structure has high image quality, but between the fifth lens and the sixth lens, the light path can generate more reflections when passing through, causing the problem of excessive stray light. The optical imaging lens assembly in this application sets a fifth supporting element on the image side of the fifth lens and satisfies 6.25< (d0m−d5s)/CT6<8.7, so that the stray light path can be blocked when passing through the fifth supporting element, and the stray light is controlled within a reasonable range, effectively controlling the reflection problem between the sixth lens and the fifth lens. Based on this, the optical imaging lens assembly provided by the embodiments of the present application can achieve both high image height and low stray light, meeting the market's high imaging quality requirements for lens assemblies, especially for lens assemblies of smart wearable devices.

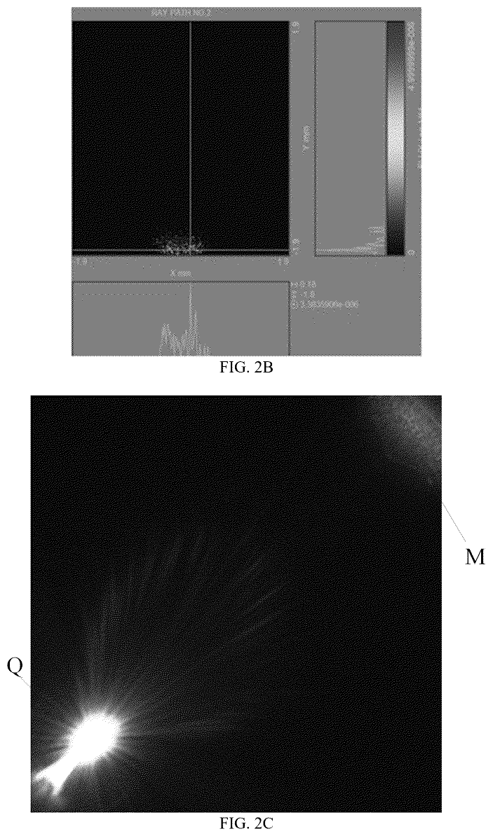

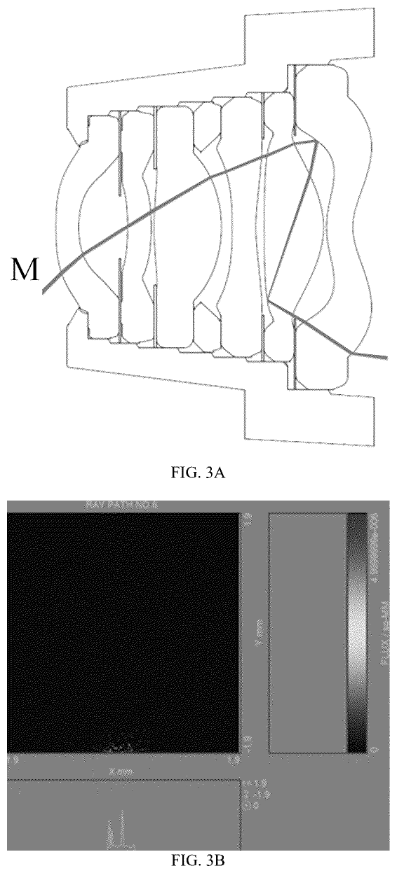

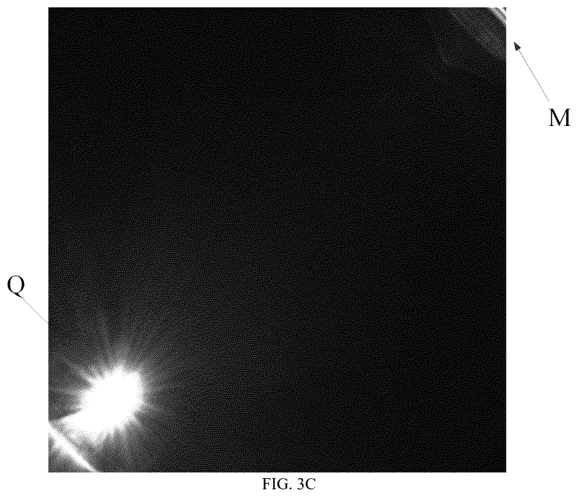

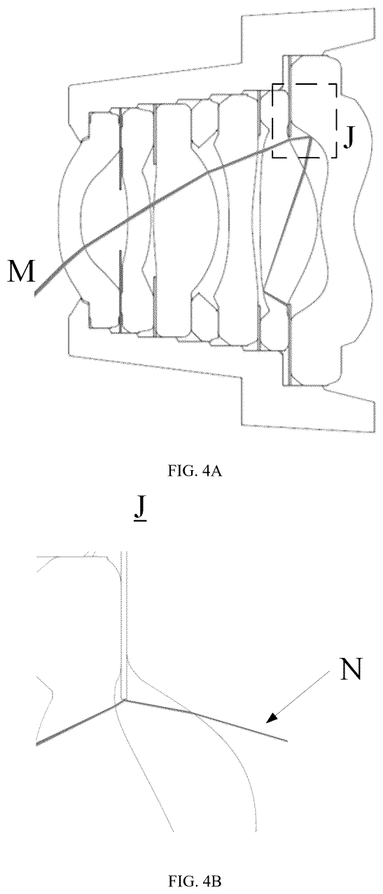

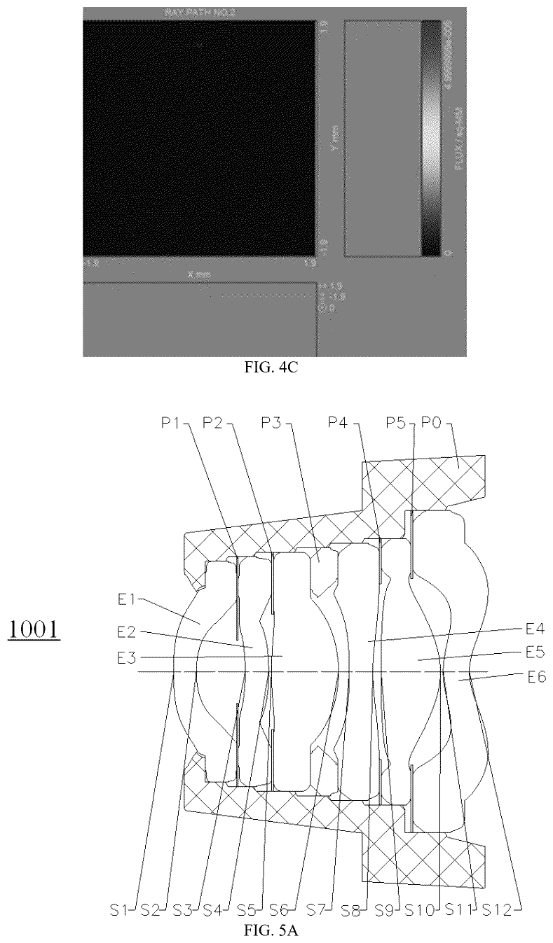

FIG. 2A shows a schematic structural diagram of an optical imaging lens assembly according to an embodiment of the present application satisfying CT5/CT6=2.27 and (d0m−d5s)/CT6=10.6; FIG. 2B shows a schematic diagram of stray light of the optical imaging lens assembly of FIG. 2A; FIG. 2C shows a schematic diagram of actual captured stray light of the optical imaging lens assembly of FIG. 2A, where Q represents the test light source and M represents stray light. As shown in FIG. 2A, when the optical imaging lens assembly satisfies (d0m−d5s)/CT6=10.6, the fifth supporting element does not block the path of the stray light M. As shown in FIGS. 2B and 2C, under this condition, the stray light of the optical imaging lens assembly is considerable and relatively obvious. FIG. 3A shows a schematic structural diagram of an optical imaging lens assembly according to an embodiment of the present application satisfying CT5/CT6=2.27 and (d0m−d5s)/CT6=6.3; FIG. 3B shows a schematic diagram of stray light of the optical imaging lens assembly of FIG. 3A; FIG. 3C shows a schematic diagram of actual captured stray light of the optical imaging lens assembly of FIG. 3A, where Q represents the test light source and M represents stray light. As shown in FIG. 3A, when the optical imaging lens assembly satisfies (d0m−d5s)/CT6=6.3, which means it satisfies the aforementioned 6.25< (d0m−d5s)/CT6<8.7, the fifth supporting element blocks the path of the stray light M. As shown in FIGS. 3B and 3C, under this condition, the stray light of the optical imaging lens assembly is slight, and stray light is basically invisible in actual captured images. FIG. 4A shows a schematic structural diagram of an optical imaging lens assembly according to an embodiment of the present application satisfying CT5/CT6=2.27 and (d0m−d5s)/CT6=4.6, FIG. 4B shows a partially enlarged schematic diagram of portion J of the optical imaging lens assembly of FIG. 4A, and FIG. 4C shows a schematic diagram of top stray light of the optical imaging lens assembly of FIG. 4A, where M represents stray light, N represents newly added top stray light, and J represents the top partial area of the optical imaging lens assembly. As shown in FIGS. 4A and 4B, when the optical imaging lens assembly satisfies (d0m−d5s)/CT6=4.6, the fifth supporting element blocks the path of the stray light M, but new top stray light N is added to the top portion J of the fifth lens and the sixth lens. As shown in FIG. 4C, under this condition, a stray light spot appears at the top of the optical imaging lens assembly.

In an exemplary embodiment, the optical imaging lens assembly satisfies: 2<TD/f<2.6; −2.1<R3/f<−1; −8.8<R3/EP12<−4.38; 10≤d2s/T23<43.2, wherein TD is the distance along the optical axis from the object-side surface of the first lens to the image-side surface of the sixth lens, f is the effective focal length of the optical imaging lens assembly, R3 is the radius of curvature of the object-side surface of the second lens, EP12 is the axial distance from the image-side surface of the first supporting element to the object-side surface of the second supporting element, d2s is the inner diameter of the object-side surface of the second supporting element, and T23 is the distance along the optical axis from the image-side surface of the second lens to the object-side surface of the third lens. While the optical imaging lens assembly structure in the above embodiment is compact and has good rendering quality, the surface profile of the second lens after camera lens assembly undergoes significant deformation due to radial pressure from the lens barrel, affecting the overall performance and stability of the lens assembly. The optical imaging lens assembly satisfies-8.8<R3/EP12<−4.38 and 10≤d2s/T23<43.2. The radial pressure from the lens barrel on the second lens in the optical imaging lens assembly always acts on the paraxial position of the second lens. In reliability experiments, especially in performance tests under high temperature and high humidity conditions, the degree of deformation of the surface profile of the second lens can be reduced, causing less change in the overall effective focal length and back focal length of the optical imaging lens assembly, thereby improving the stability of the optical imaging lens assembly.

Table 1 shows the change in effective focal length f, mechanical back focal length FFL, and on-axis MTF in S and T directions at center field, 0.4 field, 0.6 field, 0.8 field, and 1.0 field, when each experimental lens assembly is continuously tested under different time conditions (48, 160, 500 hours) at a temperature of 65° C. and humidity of 93% RH in high temperature and high humidity experiments. Taking the optical imaging lens assembly of Embodiment 1 below as an example for testing, the table below (Table 1) lists the test results for its R3/EP12 and d2s/T2 under three different conditions, when the optical imaging lens assembly satisfies TD/f=2.39, R3/f=−1.77 and remains unchanged, namely, the results for an optical imaging lens assembly satisfying R3/EP12=−4.58 and d2s/T23=42.27, an optical imaging lens assembly satisfying R3/EP12=−13.11 and d2s/T23=85.05, and an optical imaging lens assembly satisfying R3/EP12=−0.05 and d2s/T23=7.85, comprising the changes in effective focal length f, mechanical back focal length FFL, and on-axis MTF in S and T directions. Optical imaging lens assemblies with changes in effective focal length f and mechanical back focal length FFL within 3 μm are usually judged to have stronger performance and greater stability. As shown in Table 1, the optical imaging lens assembly satisfying R3/EP12=−4.58 and d2s/T23=42.27 meets this standard (i.e., the standard that the changes in effective focal length f and mechanical back focal length FFL are within 3 μm): its changes in effective focal length f and mechanical back focal length FFL are within 3 μm, and the maximum MTF drop is 1.6; the optical imaging lens assembly satisfying R3/EP12=−13.11 and d2s/T23-85.05 does not meet this standard (i.e., the standard that the changes in effective focal length f and mechanical back focal length FFL are within 3 μm): its changes in effective focal length f and mechanical back focal length FFL exceed 3-6 μm, and the maximum MTF drop is 2.0; the optical imaging lens assembly satisfying R3/EP12=−0.05 and d2s/T23=7.85 does not meet this standard (i.e., the standard that the changes in effective focal length f and mechanical back focal length FFL are within 3 μm): its changes in effective focal length f and mechanical back focal length FFL exceed 3-5 μm, and the maximum MTF drop is 6.5. The above experimental data show that the optical imaging lens assembly satisfying R3/EP12=−4.58 and d2s/T23=42.27, i.e., the optical imaging lens assembly satisfying the conditions-8.8<R3/EP12<−4.38 and 10≤d2s/T23<43.2, undergoes smaller deformation and has stronger stability under the same experimental conditions.

TABLE 1

| | | | | Change in MTF | | | | | | | | | |
|---|---|---|---|---|---|---|---|---|---|---|---|---|---|
| Parameters of the optical | Time/ | Change | Change in | Center field | | 0.4 field | | 0.6 field | | 08 field | | 1.0 field | |
| imaging lens assembly | hour | in f/mm | FFL/mm | S | T | S | T | S | T | S | T | S | T |
| R3/EP12 = −4.58 | 48 | −0.002 | −0.002 | −0.1 | −0.3 | 0.1 | −0.3 | 0.6 | 0.7 | 1.4 | 0.7 | 0.8 | 0.3 |
| d2s/T23 = 42.27 | 160 | −0.003 | −0.003 | −0.4 | −0.1 | −0.3 | 1.3 | −0.4 | 0.6 | 1.5 | 0.8 | 1.6 | 0 |
| | 500 | −0.001 | −0.002 | −1 | −0.3 | −1.3 | −1.2 | −1.6 | −0.7 | 0.1 | −0.6 | −1.5 | 0.3 |
| R3/EP12 = −13.11 | 48 | −0.005 | −0.003 | −1.1 | −1 | −1.8 | −1.4 | −1.2 | −0.9 | −0.3 | −0.6 | 0.4 | −0.3 |
| d2s/T23 = 85.05 | 160 | −0.006 | −0.003 | −0.6 | −0.8 | −0.7 | 0.9 | −0.6 | 0.1 | 0.8 | 1.6 | 0.4 | −0.1 |
| | 500 | −0.005 | −0.003 | −0.8 | −0.6 | −0.7 | 1.3 | −0.6 | −0.9 | 0.8 | −0.5 | 1.8 | −2 |
| R3/EP12 = −0.05 | 48 | −0.003 | −0.005 | −1.9 | −1.2 | −1.4 | −1.5 | −2 | −3.4 | −2.4 | −3.1 | −1.5 | −4.6 |
| d2s/T23 = 7.85 | 160 | −0.003 | −0.005 | −1.7 | −2.4 | −2.5 | −1.4 | −1.7 | −4.2 | −2.1 | −6.5 | −2 | −4.7 |
| | 500 | −0.003 | −0.003 | −2.7 | −2.3 | −3.5 | −1.7 | −2.2 | −3.3 | −0.1 | 0.8 | −1 | −3.6 |

In an exemplary embodiment, the optical imaging lens assembly satisfies: 2.1<CT3/CT4<3.2; 2.2<(CT3+CT5)/L<2.75, wherein CT3 is the central thickness of the third lens on the optical axis, CT4 is the central thickness of the fourth lens on the optical axis, CT5 is the central thickness of the fifth lens on the optical axis, and L is the distance along the optical axis from the object-side end surface to the image-side end surface of the lens barrel. Since the object-side surface of the third lens and the object-side surface of the fifth lens both receive large-angle divergent light, the SLOP angle of the edges of the image-side surfaces of the third lens and the fifth lens must be large enough to converge the light, meeting the image height specifications of the optical imaging lens assembly. However, lenses with large SLOP angles may have the problem of excessively low edge thickness in the effective aperture of the lens. Ensuring the optical imaging lens assembly satisfies the above conditions can guarantee that the edge thickness of the third lens and the fifth lens is within a range that allows for high yield manufacturing. More specifically, the optical imaging lens assembly can further satisfy: 2.6<CT5/T45<7.15, ensuring that the edge thickness of the third lens and the fifth lens is within a range that allows for high yield manufacturing.

In an exemplary embodiment, the optical imaging lens assembly satisfies: 0.45<(D0m−D0s)/TD<0.6; 0.95<L/TD<1.15, wherein D0m is the outer diameter of the image-side end surface of the lens barrel, D0s is the outer diameter of the object-side end surface of the lens barrel, TD is the distance along the optical axis from the object-side surface of the first lens to the image-side surface of the sixth lens, and L is the distance along the optical axis from the object-side end surface to the image-side end surface of the lens barrel. By making the optical imaging lens assembly satisfy the above conditions, it is beneficial for the lens barrel wall thickness to have good uniformity, meet appearance control requirements, and ensure the reliability and stability of the optical imaging lens assembly. Specifically: the distance from the object-side end surface to the image-side end surface of the lens barrel (i.e., L, which is the length of the lens barrel) is mainly controlled by the TTL of the optical imaging lens assembly and the module size. Under fixed TTL conditions, the smaller L is, the larger the mechanical back focal length of the optical imaging lens assembly is, and the greater the adjustment space for pairing the optical imaging lens assembly with the module is. Furthermore, the outer diameter of the image-side end surface of the lens barrel (i.e., D0m) is controlled by the size of the imaging surface of the optical imaging lens assembly, and the outer diameter of the object-side end surface of the lens barrel (i.e., D0s) is mainly controlled by the module window opening and the assembly support area. These dimensions collectively affect the overall appearance of the lens assembly. Meeting the above conditions can ensure good uniformity of the lens barrel wall thickness. Under conditions where the optical effective aperture of the optical imaging lens assembly is fixed, the better the uniformity of the lens barrel wall thickness, the more stable the reliability of the lens assembly. Therefore, by meeting the above conditions, the reliability of the optical imaging lens assembly is stable.

In an exemplary embodiment, the optical imaging lens assembly satisfies: 1.7<(d0m−d5m)/EP50m<2.6, wherein d0m is the inner diameter of the image-side end surface of the lens barrel, d5m is the inner diameter of the object-side surface of the fifth supporting element, and EP50m is the distance along the optical axis from the fifth supporting element to the image-side end surface of the lens barrel. In an exemplary embodiment, the fifth supporting element is the last element of the optical imaging lens assembly and can control the range of light of the optical imaging lens assembly. Its fit with the inner diameter of the image-side end surface of the lens barrel should leave sufficient space for adhesive dispensing. By ensuring the optical imaging lens assembly satisfies the above conditions, the specification requirements for the pushing force of the optical imaging lens assembly can be met, and the mechanical reliability stability of the optical imaging lens assembly can be improved, thereby enhancing the quality of the optical imaging lens assembly.

In an exemplary embodiment, the optical imaging lens assembly satisfies: −2.4<CT5/SAG52<−1.73; 0.45<EP45/CT5<0.65, wherein CT5 is the central thickness of the fifth lens on the optical axis, SAG52 is the axial distance between the intersection point of the image-side surface of the fifth lens and the optical axis and the effective radius vertex of the image-side surface of the fifth lens, and EP45 is the distance along the optical axis from the image-side surface of the fourth supporting element to the object-side surface of the fifth supporting element. In an exemplary embodiment, the fifth lens can be an aspherical glass lens. Making the optical imaging lens assembly satisfy the above conditions can ensure the surface profile accuracy of the fifth lens during die casting, reduce the risk of cracking of the fifth lens, and improve the molding yield of the fifth lens, thereby reducing the production cost of the optical imaging lens assembly.

In an exemplary embodiment, the distance along the optical axis from the image-side surface of the first lens to the object-side surface of the second lens is the largest compared to the distances along the optical axis between any other two adjacent lenses (e.g., the distance along the optical axis from the image-side surface of the second lens to the object-side surface of the third lens). The optical imaging lens assembly satisfies: 0.7<CT1/ET1≤1.3; 0.4<EP01/(CT1+T12)<1.25, wherein CT1 is the central thickness of the first lens on the optical axis, ET1 is the edge thickness of the first lens in the effective optical region, EP01 is the distance along the optical axis from the object-side end surface of the lens barrel to the object-side surface of the first supporting element, and T12 is the distance along the optical axis from the image-side surface of the first lens to the object-side surface of the second lens. In an exemplary embodiment, the first lens has the effect of converging light and can collect light from its object side. Making the optical imaging lens assembly satisfy the above conditions can ensure that the first lens can collect light at a sufficient angle to meet the field of view requirements of the optical imaging lens assembly; at the same time, it can also meet the demand for sufficient physical strength of the lens barrel to withstand the pressure generated during lens assembly and use without blocking the light of the optical imaging lens assembly, thereby improving the assembly stability between the lens barrel and the first lens.

In an exemplary embodiment, the optical imaging lens assembly satisfies: 0.35<(d5s−d2m)/Tr5r10<0.7, wherein d5s is the inner diameter of the object-side surface of the fifth supporting element, d2m is the inner diameter of the image-side surface of the second supporting element, and Tr5r10 is the distance along the optical axis from the object-side surface of the third lens to the image-side surface of the fifth lens. In an exemplary embodiment, the inner diameter from the second supporting element to the fifth supporting element gradually increases. In other words, the inner diameter of the third supporting element is greater than the inner diameter of the second supporting element, the inner diameter of the fourth supporting element is greater than the inner diameter of the third supporting element, and the inner diameter of the fifth supporting element is greater than the inner diameter of the fourth supporting element. By ensuring the optical imaging lens assembly satisfies the above conditions, it is possible to control the light rays emitted from the aperture stop to smoothly hit the imaging surface, avoiding the appearance of large-angle light rays, thereby satisfying the image height requirements of the optical imaging lens assembly and reducing stray light generated when large-angle light rays hit the flange structure of the optical imaging lens assembly, thus improving the imaging quality of the optical imaging lens assembly.

In an exemplary embodiment, the optical imaging lens assembly satisfies: −1.1<R6/f3<−0.65; −9.47<SAG32/SAG31<−2.85; 1.45<CT3/EP23<2.75, wherein R6 is the radius of curvature of the image-side surface of the third lens, f3 is the effective focal length of the third lens, SAG32 is the axial distance between the intersection point of the image-side surface of the third lens and the optical axis and the effective radius vertex of the image-side surface of the third lens, SAG31 is the axial distance between the intersection point of the object-side surface of the third lens and the optical axis and the effective radius vertex of the object-side surface of the third lens, CT3 is the central thickness of the third lens on the optical axis, and EP23 is the distance along the optical axis from the image-side surface of the second supporting element to the object-side surface of the third supporting element. By ensuring the optical imaging lens assembly satisfies the above conditions, and by reasonably controlling the edge thickness of the third lens and the central thickness of the third lens on the optical axis, it can be ensured that the third lens has good processing feasibility, and that the accuracy of the support position between the lenses of the assembled optical imaging lens assembly is maintained, so that the optical parameters of the optical imaging lens assembly meet the design requirements. In addition, it can also prevent interference in the optical axis direction between the effective aperture surfaces of the lenses of the assembled optical imaging lens assembly, avoiding appearance problems and performance anomalies of the lenses, thereby improving the appearance and performance production yield of the optical imaging lens assembly.

In an exemplary embodiment, the absolute value of the effective focal length of the third lens is less than the absolute value of the effective focal length of other lenses, and the optical imaging lens assembly satisfies: 0.75<f3/f<1.05; 0.35<d3s/D3s<0.75, wherein f3 is the effective focal length of the third lens, f is the effective focal length of the optical imaging lens assembly, d3s is the inner diameter of the object-side surface of the third supporting element, and D3s is the outer diameter of the object-side surface of the third supporting element. In an exemplary embodiment, the inner and outer diameters of the third supporting element reflect the length of the flange portion of the third lens, and the third lens can have a convex profile, leading to a smaller edge thickness in the effective aperture of the third lens. In an exemplary embodiment, the third lens may have the most convex profile compared to other lenses. Ensuring the optical imaging lens assembly satisfies the above conditions can prevent the injected adhesive from cooling too quickly due to the excessively long flange portion of the third part during lens molding, thereby avoiding appearance problems such as flow marks on the edges of the third lens, thus improving the quality of the third lens.

In an exemplary embodiment, the optical imaging lens assembly satisfies: 0≤SAG51/CT5<0.2; 0.7<d4m/f5<1.3, wherein SAG51 is the axial distance between the intersection point of the object-side surface of the fifth lens and the optical axis and the effective radius vertex of the object-side surface of the fifth lens, CT5 is the central thickness of the fifth lens on the optical axis, d4m is the inner diameter of the image-side surface of the fourth supporting element, and f5 is the effective focal length of the fifth lens. In an exemplary embodiment, the fifth lens can be a glass lens. By ensuring the optical imaging lens assembly satisfies the above conditions, the fifth lens has a plano-convex combination shape, allowing the fifth lens to be formed by die casting. Specifically, during die casting, it can be molded by positioning the convex surface and pressing down on the planar surface. This can ensure that the inter-surface eccentricity of the fifth lens is a small value, and can also reduce trapped air, improve the appearance yield of the fifth lens, and reduce the risk of stray light in the optical imaging lens assembly.

In an exemplary embodiment, the optical imaging lens assembly satisfies: 0.1<T34/CT4<0.55; 0.45< (D4s−D3s)/(T34+CT4+T45)<1.38, wherein T34 is the distance along the optical axis from the image-side surface of the third lens to the object-side surface of the fourth lens, CT4 is the central thickness of the fourth lens on the optical axis, T45 is the distance along the optical axis from the image-side surface of the fourth lens to the object-side surface of the fifth lens, D4s is the outer diameter of the object-side surface of the fourth supporting element, and D3s is the outer diameter of the object-side surface of the third supporting element. In an exemplary embodiment, the fourth lens can be formed by injection molding. By ensuring the optical imaging lens assembly satisfies the above conditions, the outer diameter of the fourth lens can be effectively controlled, thereby effectively controlling the ratio of the outer diameter of the fourth lens to the central thickness of the fourth lens on the optical axis, which is beneficial for reducing the injection molding risk of the fourth lens. In addition, by controlling the outer diameter size of the fourth lens, it helps to ensure the uniformity of the wall thickness of the lens barrel and reduces the risk of abnormal appearance of the lens barrel due to local uneven wall thickness during injection molding.

In an exemplary embodiment, the inner wall of the lens barrel has a transverse step between the locations where the fourth supporting element and the fifth supporting element contact the inner wall of the lens barrel, and the optical imaging lens assembly satisfies: 6.54<d5s/T56<76.1; 0.75<(D5m-D4m)/EP45<2.1, wherein d5s is the inner diameter of the object-side surface of the fifth supporting element, T56 is the distance along the optical axis from the image-side surface of the fifth lens to the object-side surface of the sixth lens, D5m is the outer diameter of the image-side surface of the fifth supporting element, D4m is the outer diameter of the image-side surface of the fourth supporting element, and EP45 is the distance along the optical axis from the image-side surface of the fourth supporting element to the object-side surface of the fifth supporting element. Since light begins to diverge at a large angle from the fourth lens, to ensure that the imaging surface meets the specification requirements, the effective aperture of the fifth lens and the sixth lens must also increase accordingly. By providing this transverse step, it can be ensured that the fifth lens and the sixth lens are in a relatively stable support line with the preceding lenses (e.g., the fourth lens), while also ensuring that the fifth lens and the sixth lens have sufficient flange length to meet the design of the support position and the gate space, thereby improving the assembly stability of the optical imaging lens assembly and increasing the lens molding yield.

In an exemplary embodiment, the optical imaging lens assembly satisfies: 0.4≤(D5m−D4m)/(D0m−d0m)<0.95, wherein D5m is the outer diameter of the image-side surface of the fifth supporting element, D4m is the outer diameter of the image-side surface of the fourth supporting element, D0m is the outer diameter of the image-side end surface of the lens barrel, and d0m is the inner diameter of the image-side end surface of the lens barrel. Under the condition of a fixed wall thickness of the lens barrel, the larger the image height (i.e., ImgH) of the optical imaging lens assembly, the larger the outer diameter of the rear end surface of the lens barrel (i.e., D0m), the larger the light transmission space, and the higher the imaging quality of the optical imaging lens assembly. Making the optical imaging lens assembly satisfy the above conditions is beneficial for ensuring the performance and appearance of the optical imaging lens assembly and for ensuring the compatibility between the optical imaging lens assembly and the chip.

In an exemplary embodiment, the optical imaging lens assemblies satisfies: 1.33<tan (FOV/2)<1.56; −2.7<f1/f<−1.9; 3.6<(d0s−d1s)/CT1<6.45, wherein FOV is the maximum field angle of the optical imaging lens assembly, f1 is the effective focal length of the first lens, f is the effective focal length of the optical imaging lens assembly, dos is the inner diameter of the object-side end surface of the lens barrel, d1s is the inner diameter of the object-side surface of the first supporting element, and CT1 is the central thickness of the first lens on the optical axis. Making the optical imaging lens assembly satisfy the above conditions is beneficial for ensuring that the optical imaging lens assembly can meet normal shooting requirements. Specifically: the minimum inner diameter (i.e., ds) of the front part of the lens barrel facing the object to be photographed should be greater than the diameter of the profile circle corresponding to the maximum field of view (i.e., FOV) at that position (the diameter size is 2 tan (FOV/2)×VP, where VP is the distance from that position to the convergence point of the maximum field of view (i.e., FOV) on the optical axis). Furthermore, the outer diameter of the object-side end surface of the lens barrel must meet the assembly requirements of the optical imaging lens assembly. Therefore, when designing the lens barrel, it must not only avoid light blocking, but also ensure that it helps prevent the width of the annular flat surface of the lens barrel near the object plane being photographed is not too small, i.e., it must ensure both normal shooting and normal assembly.

In an exemplary embodiment, the optical imaging lens assembly satisfies: at least 2 lenses have a refractive index greater than 1.6, wherein the refractive index of the fourth lens is greater than 1.6; and 0.5<ET4/(CP3+EP34+CP4)<0.7, wherein ET4 is the edge thickness of the fourth lens in the effective optical region, CP3 is the distance along the optical axis from the object-side surface to the image-side surface of the third supporting element, EP34 is the distance along the optical axis from the image-side surface of the third supporting element to the object-side surface of the fourth supporting element, and CP4 is the distance along the optical axis from the object-side surface to the image-side surface of the fourth supporting element. By making the optical imaging lens assembly satisfy the above conditions, the quality of the lens assembly can be improved. Specifically: in an exemplary embodiment, the fourth lens has a structure that is thin in the middle and thick at edges, and the image-side surface of the third lens is convex. The thickness of the third supporting element can control the thickness ratio of the fourth lens, ensuring good machinability of the fourth lens. In an exemplary embodiment, the third supporting element can be an injection molded part. By controlling the thickness of the third supporting element within a reasonable range, the injection molding feasibility of the spacer ring can be ensured.

In the embodiments of the present application, at least one of the lens surfaces of each lens is an aspherical lens surface, that is, at least one lens surface from the object-side surface of the first lens to the image-side surface of the sixth lens is an aspherical lens surface. The characteristics of aspherical lenses are that the curvature continuously changes from the center of the lens to its periphery. Unlike spherical lenses, which have a constant curvature from the center of the lens to its periphery, aspherical lenses have better curvature radius characteristics and the advantages of improving distortion aberration and astigmatism aberration. By using aspherical lenses, aberrations that occur during imaging can be eliminated as much as possible, thereby improving imaging quality. Optionally, the object-side surface and the image-side surface of all lenses from the first lens to the sixth lens are aspherical lens surfaces.

In an exemplary embodiment, the optical imaging lens assembly described above may further comprise a filter for correcting color deviation and/or a protective glass for protecting the photosensitive element located on the imaging surface. Light from the object sequentially passes through each surface of the optical lens group to the filter and/or protective glass and finally forms an image on the imaging surface.

The optical imaging lens assembly according to the above embodiments of the present application can use multiple lenses, for example, the six lenses mentioned above. By reasonably allocating the refractive power and surface profile of each lens, along with the arrangement of each supporting element, the fit intervals between the lenses and the lens barrel are relatively uniform, enhancing the ability of light convergence and improving the imaging quality of wide-angle, large-image-plane optical imaging lens assemblies. However, those skilled in the art should understand that the number of lenses forming the optical imaging lens assembly can be changed to obtain the various results and advantages described in this specification without departing from the technical solution claimed in the present application. For example, although described with six lenses in the embodiment, the optical imaging lens assembly is not limited to comprising six lenses. If desired, the optical imaging lens assembly may also comprise other numbers of lenses.

Specific embodiments of the optical imaging lens assembly applicable to the above embodiments are further described below with reference to the accompanying drawings.

### Embodiment 1

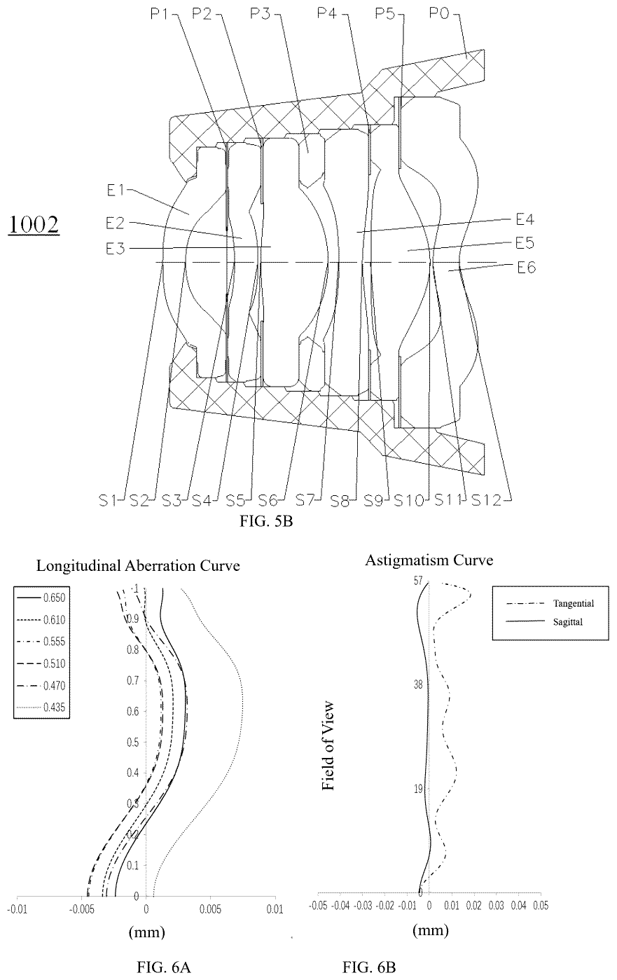

FIG. 5A shows a schematic structural diagram of an optical imaging lens assembly 1001 according to Embodiment 1 of the present application. As shown in FIG. 5A, the optical imaging lens assembly 1001 comprises a lens barrel P0, a lens group E1˜E6, and a supporting element group P1˜P5. The optical imaging lens assembly 1001 also comprises an aperture stop STO (not shown) located between the first lens and the second lens.

As shown in FIG. 5A, the lens group of the optical imaging lens assembly 1001 sequentially comprises, from the object side to the image side: a first lens E1, a second lens E2, a third lens E3, a fourth lens E4, a fifth lens E5, and a sixth lens E6. Among them, the object-side surface S1 of the first lens E1 is a convex surface, and the image-side surface S2 is a concave surface. The object-side surface S3 of the second lens E2 is a concave surface, and the image-side surface S4 is a convex surface. The object-side surface S5 of the third lens E3 is a convex surface, and the image-side surface S6 is a convex surface. The object-side surface S7 of the fourth lens E4 is a concave surface, and the image-side surface S8 is a concave surface. The object-side surface S9 of the fifth lens E5 is a convex surface, and the image-side surface S10 is a convex surface. The object-side surface S11 of the sixth lens E6 is a convex surface, and the image-side surface S12 is a concave surface. The optical imaging lens assembly 1001 further comprises a filter (not shown) for correcting color deviation, and the filter has an object-side surface S13 (not shown) and an image-side surface S14 (not shown). Light from the object sequentially passes through surfaces S1 to S14 and finally forms an image on the imaging surface S15 (not shown).

Table 2 shows the basic parameter table of the lens group of the optical imaging lens assembly 1001 of Embodiment 1, where the units for radius of curvature, thickness/distance, and effective focal length are all millimeters (mm).

TABLE 2

| | | | | Material | | |
|---|---|---|---|---|---|---|
| Surface | | Radius of | Thickness/ | Refractive | Abbe | Cone |
| number | Surface type | Curvature | Distance | Index | number | coefficient |
| OBJ | spherical | Infinity | 400.0000 | | | |
| S1 | aspherical | 4.2289 | 0.2500 | 1.546 | 56.1 | −11.6668 |
| S2 | aspherical | 1.2004 | 0.4494 | | | 2.0875 |
| STO | spherical | Infinity | 0.0849 | | | |
| S3 | aspherical | −2.3980 | 0.2566 | 1.536 | 55.7 | −10.5403 |
| S4 | aspherical | −2.4580 | 0.0300 | | | −1.7304 |
| S5 | aspherical | 2.9793 | 0.7347 | 1.778 | 81.61 | −81.3390 |
| S6 | aspherical | −1.3279 | 0.1168 | | | 1.0507 |
| S7 | aspherical | −7.0278 | 0.2572 | 1.666 | 20.4 | −7.2306 |
| S8 | aspherical | 1.8112 | 0.0914 | | | −34.4450 |
| S9 | aspherical | 40.5489 | 0.6483 | 1.546 | 56.1 | 5.0000 |
| S10 | aspherical | −0.9294 | 0.0310 | | | −2.3153 |
| S11 | aspherical | 0.9588 | 0.2858 | 1.666 | 20.4 | −10.3674 |
| S12 | aspherical | 0.6274 | 0.3488 | | | −3.6969 |
| S13 | spherical | Infinity | 0.2100 | 1.52 | 64.2 | |
| S14 | spherical | Infinity | 0.4003 | | | |
| S15 | spherical | Infinity | | | | |

In Embodiment 1, the object-side surface and the image-side surface of any one of the first lens E1 to the sixth lens E6 are aspherical, and the surface profiles X of each aspherical lens can be defined by, but are not limited to, the following aspherical formula:

$$x = \frac{{ch}^{2}}{1 + \sqrt{1 - ( k + 1 ) {c}^{2} {h}^{2}}} + \sum {Aih}^{i} \qquad ( 1 )$$

Where X is the sagittal height of the aspherical surface, which is the distance from the vertex of the aspherical surface in the direction of the optical axis at a height h; c is the paraxial curvature of the aspherical surface, c=1/R (i.e., the paraxial curvature c is the reciprocal of the radius of curvature R in Table 1 above); k is the cone coefficient; and Ai is the i-th order correction coefficient of the aspherical surface. Tables 3-1 and 3-2 provide the higher-order coefficients A4, A6, A8, A10, A12, A14, A16, A18, A20 that can be used for each aspherical surface S1-S12 in Embodiment 1.

TABLE 3-1

| Surface number | A4 | A6 | A8 | A10 | A12 |
|---|---|---|---|---|---|
| S1 | 7.0846E−01 | −1.1447E+00 | 2.8279E+00 | −8.5975E+00 | 2.4660E+01 |
| S2 | 8.5323E−01 | 2.7801E+00 | −5.2356E+01 | 4.4406E+02 | −2.2365E+03 |
| S3 | −1.0559E−01 | −1.6246E+00 | 2.1557E+01 | −6.9393E+01 | −6.8445E+03 |
| S4 | −4.3927E−01 | 7.8128E−03 | 8.5383E+00 | −4.3740E+01 | −7.2981E+02 |
| S5 | 5.9099E−02 | −8.8105E−01 | 5.0333E+00 | −2.7044E+01 | 9.8631E+01 |
| S6 | 1.3650E−01 | −1.8566E+00 | 1.6842E+01 | −9.0689E+01 | 2.9821E+02 |
| S7 | −5.3012E−01 | 5.8801E−02 | 1.1153E+01 | −6.8728E+01 | 2.1317E+02 |
| S8 | −1.9124E−01 | −1.9617E−01 | 5.2245E+00 | −2.4005E+01 | 5.8524E+01 |
| S9 | 1.4039E−01 | −6.5993E−01 | 3.6526E+00 | −1.2436E+01 | 2.4883E+01 |
| S10 | −5.3235E−02 | 1.3503E+00 | −8.0603E+00 | 2.7949E+01 | −5.9997E+01 |
| S11 | 1.8262E−01 | −2.6139E+00 | 6.1773E+00 | −9.5715E+00 | 1.1865E+01 |
| S12 | −2.2701E−01 | −7.2851E−01 | 2.7114E+00 | −4.6192E+00 | 4.6644E+00 |

TABLE 3-2

| Sur- | | | | |
|---|---|---|---|---|
| face | | | | |
| num- | | | | |
| ber | A14 | A16 | A18 | A20 |
| S1 | −5.0731E+01 | 6.3429E+01 | −4.3656E+01 | 1.2771E+01 |
| S2 | 7.1410E+03 | −1.4567E+04 | 1.7384E+04 | −9.6687E+03 |
| S3 | 1.4803E+05 | −1.3696E+06 | 6.1179E+06 | −1.0799E+07 |
| S4 | 1.1030E+04 | −6.1159E+04 | 1.5784E+05 | −1.5945E+05 |
| S5 | −1.4091E+02 | −2.6117E+02 | 1.1296E+03 | −1.0865E+03 |
| S6 | −6.0978E+02 | 7.6433E+02 | −5.3922E+02 | 1.6379E+02 |
| S7 | −3.9412E+02 | 4.4358E+02 | −2.8417E+02 | 8.0441E+01 |
| S8 | −8.5890E+01 | 7.6224E+01 | −3.7857E+01 | 8.1095E+00 |
| S9 | −2.9615E+01 | 2.0842E+01 | −8.0025E+00 | 1.2829E+00 |
| S10 | 8.0024E+01 | −6.4486E+01 | 2.8877E+01 | −5.5328E+00 |
| S11 | −1.4214E+01 | 1.3390E+01 | −7.2838E+00 | 1.6434E+00 |
| S12 | −2.9292E+00 | 1.1176E+00 | −2.3501E−01 | 2.0606E−02 |

As shown in FIG. 5A, the optical imaging lens assembly 1001 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 4 shows the basic parameter table for the supporting elements and the lens barrel P0 of the optical imaging lens assembly 1001. All parameters in Table 4 are in millimeters (mm). These supporting elements can block excess external light from entering, allowing the lenses to be better supported by the lens barrel, and enhancing the structural stability of the optical imaging lens assembly 1001.

TABLE 4

| Parameters | d1s | d2s | d2m | d3s | D3s | d4m | D4s | D4m | d5s | D5m | EP12 |
|---|---|---|---|---|---|---|---|---|---|---|---|
| Value | 0.69 | 1.27 | 1.27 | 1.8 | 2.49 | 1.95 | 2.93 | 2.93 | 2.04 | 3.54 | 0.36 |

| Parameter | EP23 | CP3 | EP34 | CP4 | EP45 | L | EP50 | d0s | d0m | D0s | D0m |
|---|---|---|---|---|---|---|---|---|---|---|---|
| Value | 0.4 | 0.3 | 0.45 | 0.02 | 0.34 | 3.29 | 0.8 | 2.2 | 3.84 | 2.99 | 4.76 |

### Embodiment 2

FIG. 5B shows a schematic structural diagram of an optical imaging lens assembly 1002 according to Embodiment 2 of the present application. In this and the following embodiments, some descriptions similar to Embodiment 1 will be omitted for brevity.

As shown in FIG. 5B, the optical imaging lens assembly 1002 comprises a lens barrel P0, a lens group E1˜E6, and a supporting element group P1˜P5. The optical imaging lens assembly 1002 also comprises an aperture stop STO (not shown) located between the first lens and the second lens. The lens group of the optical imaging lens assembly 1002 is exactly the same as the lens group of the optical imaging lens assembly 1001 in Embodiment 1, and its basic parameters are detailed in Tables 1 to 3-2, which will not be repeated here.

As shown in FIG. 5B, the optical imaging lens assembly 1002 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 5 shows the basic parameter table for the supporting elements and the lens barrel P0 of the optical imaging lens assembly 1002. All parameters in Table 5 are in millimeters (mm). These supporting elements can block excess external light from entering, allowing the lenses to be better supported by the lens barrel, and enhancing the structural stability of the optical imaging lens assembly 1002.

TABLE 5

| Parameters | d1s | d2s | d2m | d3s | D3s | d4m | D4s | D4m | d5s | D5m | EP12 |
|---|---|---|---|---|---|---|---|---|---|---|---|
| Value | 0.69 | 1.29 | 1.29 | 1.8 | 2.59 | 1.93 | 3.03 | 3.03 | 2.07 | 3.64 | 0.36 |

| Parameter | EP23 | CP3 | EP34 | CP4 | EP45 | L | EP50 | d0s | d0m | D0s | D0m |
|---|---|---|---|---|---|---|---|---|---|---|---|
| Value | 0.39 | 0.28 | 0.48 | 0.02 | 0.31 | 3.43 | 0.91 | 2.29 | 4.01 | 3.11 | 4.68 |

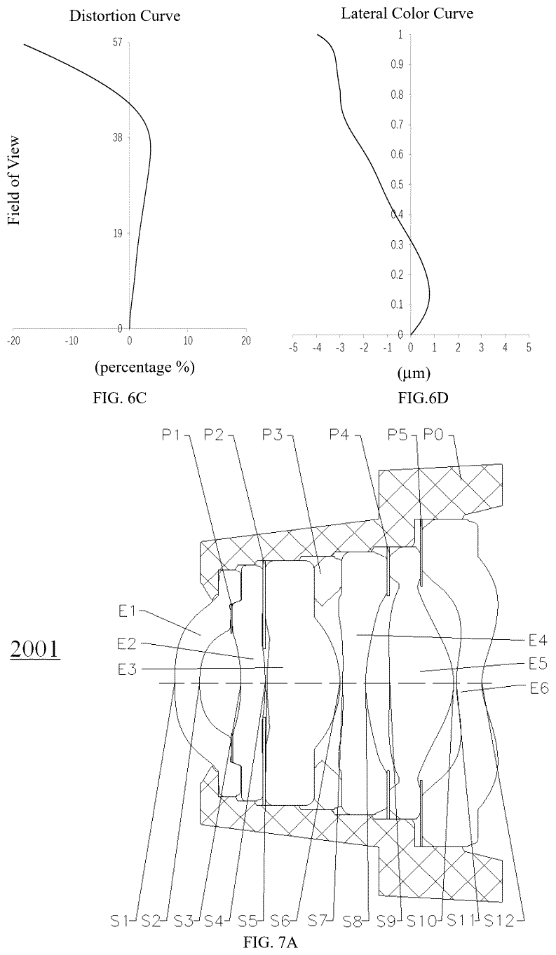

FIG. 6A shows the longitudinal aberration curves of the optical imaging lens assembly 1001 of Embodiment 1 and the optical imaging lens assembly 1002 of Embodiment 2. FIG. 6B shows the astigmatism curves of the optical imaging lens assembly 1001 of Embodiment 1 and the optical imaging lens assembly 1002 of Embodiment 2. FIG. 6C shows the distortion curves of the optical imaging lens assembly 1001 of Embodiment 1 and the optical imaging lens assembly 1002 of Embodiment 2. FIG. 6D shows the lateral color curves of the optical imaging lens assembly 1001 of Embodiment 1 and the optical imaging lens assembly 1002 of Embodiment 2. Based on FIGS. 6A to 6D, it can be seen that the optical imaging lens assembly 1001 and the optical imaging lens assembly 1002 according to Embodiment 1 and Embodiment 2 can achieve excellent imaging quality.

### Embodiment 3

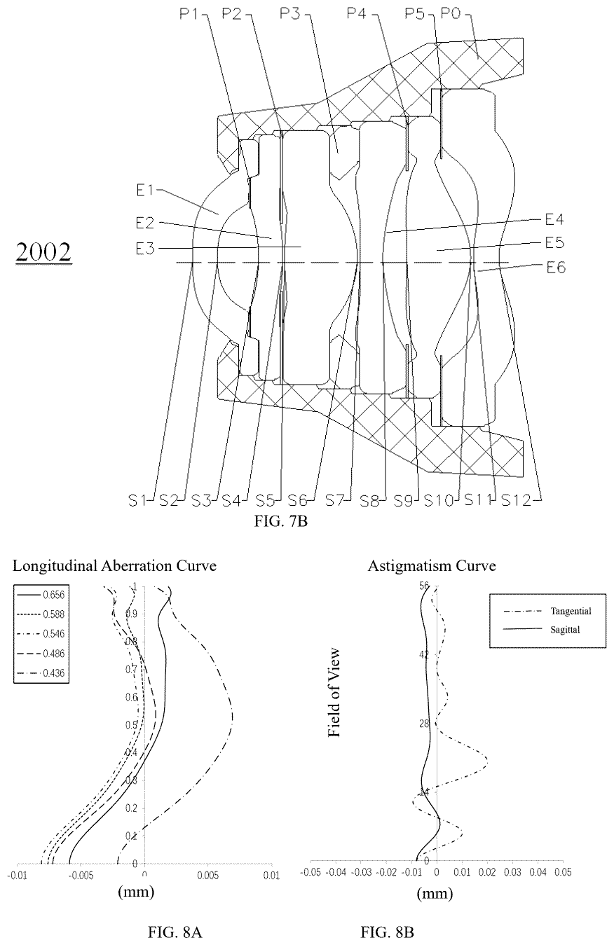

FIG. 7A shows a schematic structural diagram of an optical imaging lens assembly 2001 according to Embodiment 3 of the present application. As shown in FIG. 7A, the optical imaging lens assembly 2001 comprises a lens barrel P0, a lens group E1˜E6, and a supporting element group P1˜P5. The optical imaging lens assembly 2001 also comprises an aperture stop STO (not shown) located between the second lens and the third lens.

As shown in FIG. 7A, the lens group of the optical imaging lens assembly 2001 sequentially comprises, from the object side to the image side: a first lens E1, a second lens E2, a third lens E3, a fourth lens E4, a fifth lens E5, and a sixth lens E6. Among them, the object-side surface S1 of the first lens E1 is a convex surface, and the image-side surface S2 is a concave surface. The object-side surface S3 of the second lens E2 is a concave surface, and the image-side surface S4 is a convex surface. The object-side surface S5 of the third lens E3 is a convex surface, and the image-side surface S6 is a convex surface. The object-side surface S7 of the fourth lens E4 is a convex surface, and the image-side surface S8 is a concave surface. The object-side surface S9 of the fifth lens E5 is a concave surface, and the image-side surface S10 is a convex surface. The object-side surface S11 of the sixth lens E6 is a convex surface, and the image-side surface S12 is a concave surface. The optical imaging lens assembly 2001 also comprises a filter (not shown) for correcting color deviation, and the filter has an object-side surface S13 (not shown) and an image-side surface S14 (not shown). Light from the object sequentially passes through surfaces S1 to S14 and finally forms an image on the imaging surface S15 (not shown).

Table 6 shows the basic parameter table of the lens group of the optical imaging lens assembly 2001 of Embodiment 3, where the units for radius of curvature, thickness/distance, and effective focal length are all millimeters (mm). Tables 7-1 and 7-2 show the higher-order coefficients for each aspherical surface in Embodiment 3, where each aspherical surface profile can be defined by Formula (1) given in Embodiment 1 above.

TABLE 6

| | | | | Material | | |
|---|---|---|---|---|---|---|
| Surface | | Radius of | | Refractive | Abbe | Cone |
| number | Surface type | Curvature | Thickness/Distance | Index | number | coefficient |
| OBJ | spherical | Infinity | 400.0000 | | | |
| S1 | aspherical | 3.6429 | 0.2711 | 1.546 | 56.1 | −64.1105 |
| S2 | aspherical | 1.2637 | 0.4515 | | | 1.0310 |
| S3 | aspherical | −1.6616 | 0.2622 | 1.546 | 56.1 | −7.5311 |
| S4 | aspherical | −3.1439 | −0.0098 | | | 5.0000 |
| STO | spherical | Infinity | 0.0300 | | | |
| S5 | aspherical | 2.7249 | 0.7940 | 1.747 | 49.34 | −59.7656 |
| S6 | aspherical | −1.0796 | 0.0300 | | | 0.6116 |
| S7 | aspherical | 7.9661 | 0.2500 | 1.666 | 20.4 | −99.0120 |
| S8 | aspherical | 1.4968 | 0.2620 | | | −19.8833 |
| S9 | aspherical | −6.2804 | 0.6953 | 1.546 | 56.1 | −27.1548 |
| S10 | aspherical | −0.7753 | 0.0300 | | | −2.6315 |
| S11 | aspherical | 1.3088 | 0.2776 | 1.666 | 20.4 | −38.1655 |
| S12 | aspherical | 0.6731 | 0.3140 | | | −1.3830 |
| S13 | spherical | Infinity | 0.2100 | 1.52 | 64.2 | |
| S14 | spherical | Infinity | 0.4004 | | | |
| S15 | spherical | Infinity | | | | |

TABLE 7-1

| Surface number | A4 | A6 | A8 | A10 | A12 |
|---|---|---|---|---|---|
| S1 | 8.5925E−01 | −1.2463E+00 | 2.9637E+00 | −7.6064E+00 | 2.1733E+01 |
| S2 | 9.8753E−01 | 4.8965E+00 | −9.6544E+01 | 1.1469E+03 | −8.5226E+03 |
| S3 | 6.9367E−02 | −4.9464E−01 | −1.0605E+01 | 1.5795E+02 | −1.2131E+03 |
| S4 | 2.5656E−01 | −1.1877E+01 | 2.9429E+02 | −5.8964E+03 | 8.1816E+04 |
| S5 | 2.8478E−01 | −6.0543E+00 | 7.0112E+01 | −6.3249E+02 | 3.8091E+03 |
| S6 | −1.0166E−01 | 3.1013E+00 | −2.4890E+01 | 9.9439E+01 | −1.0566E+02 |
| S7 | −8.4593E−01 | 6.3976E+00 | −4.4648E+01 | 1.8949E+02 | −4.3753E+02 |
| S8 | −4.9213E−02 | 8.4916E−01 | −2.4540E+00 | −1.0890E+01 | 9.8962E+01 |
| S9 | 1.7088E−01 | −1.1190E+00 | 1.0861E+01 | −4.5343E+01 | 1.0455E+02 |
| S10 | 7.4941E−02 | −2.2002E−01 | −4.9293E+00 | 3.6134E+01 | −1.0246E+02 |
| S11 | 9.3269E−01 | −9.1773E+00 | 3.4791E+01 | −8.1218E+01 | 1.2738E+02 |
| S12 | −1.2993E+00 | 1.5666E+00 | −3.1428E−01 | −2.0404E+00 | 3.3076E+00 |

TABLE 7-2

| Sur- | | | | |
|---|---|---|---|---|
| face | | | | |
| num- | | | | |
| ber | A14 | A16 | A18 | A20 |
| S1 | −4.6700E+01 | 6.2450E+01 | −4.5632E+01 | 1.3494E+01 |
| S2 | 4.1220E+04 | −1.2426E+05 | 2.1204E+05 | −1.5662E+05 |
| S3 | 5.6038E+03 | −1.5442E+04 | 2.2898E+04 | −1.3419E+04 |
| S4 | −7.3567E+05 | 4.0655E+06 | −1.2505E+07 | 1.6359E+07 |
| S5 | −1.3019E+04 | 1.4278E+04 | 4.4818E+04 | −1.1515E+05 |
| S6 | −6.2709E+02 | 2.6348E+03 | −3.9982E+03 | 2.2396E+03 |
| S7 | 4.0491E+02 | 3.1233E+02 | −9.7384E+02 | 5.8629E+02 |
| S8 | −3.0277E+02 | 4.7250E+02 | −3.7801E+02 | 1.2315E+02 |
| S9 | −1.4393E+02 | 1.1811E+02 | −5.3412E+01 | 1.0261E+01 |
| S10 | 1.5318E+02 | −1.2803E+02 | 5.6688E+01 | −1.0374E+01 |
| S11 | −1.3645E+02 | 9.5269E+01 | −3.8575E+01 | 6.7901E+00 |
| S12 | −2.6126E+00 | 1.1910E+00 | −2.9910E−01 | 3.2014E−02 |

As shown in FIG. 7A, the optical imaging lens assembly 2001 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 8 shows the basic parameter table for the supporting elements and the lens barrel P0 of the optical imaging lens assembly 2001. All parameters in Table 8 are in millimeters (mm). These supporting elements can block excess external light from entering, allowing the lenses to be better supported by the lens barrel, and enhancing the structural stability of the optical imaging lens assembly 2001.

TABLE 8

| Parameter | d1s | d2s | d2m | d3s | D3s | d4m | D4s | D4m | d5s | D5m | EP12 |
|---|---|---|---|---|---|---|---|---|---|---|---|
| Value | 1.11 | 0.75 | 0.75 | 1.86 | 2.64 | 1.93 | 2.9 | 2.9 | 2.14 | 3.61 | 0.33 |
| Parameter | EP23 | CP3 | EP34 | CP4 | EP45 | L | EP50 | d0s | d0m | D0s | D0m |
| Value | 0.54 | 0.3 | 0.49 | 0.02 | 0.34 | 3.29 | 0.87 | 2.26 | 3.91 | 3.06 | 4.83 |

### Embodiment 4

FIG. 7B shows a schematic structural diagram of an optical imaging lens assembly 2002 according to Embodiment 4 of the present application. In this and the following embodiments, some descriptions similar to Embodiment 3 will be omitted for brevity.

As shown in FIG. 7B, the optical imaging lens assembly 2002 comprises a lens barrel P0, a lens group E1˜E6, and a supporting element group P1˜P5. The optical imaging lens assembly 2002 also comprises an aperture stop STO (not shown) located between the second lens and the third lens. The lens group of the optical imaging lens assembly 2002 is exactly the same as the lens group of the optical imaging lens assembly 2001 in Embodiment 3, and its basic parameters are detailed in Tables 6 to 7-2, which will not be repeated here.

As shown in FIG. 7B, the optical imaging lens assembly 2002 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 9 shows the basic parameter table for the supporting elements and the lens barrel P0 of the optical imaging lens assembly 2002. All parameters in Table 9 are in millimeters (mm). These supporting elements can block excess external light from entering, allowing the lenses to be better supported by the lens barrel, and enhancing the structural stability of the optical imaging lens assembly 2002.

TABLE 9

| Parameter | d1s | d2s | d2m | d3s | D3s | d4m | D4s | D4m | d5s | D5m | EP12 |
|---|---|---|---|---|---|---|---|---|---|---|---|
| Value | 1.09 | 0.75 | 0.75 | 1.85 | 2.74 | 1.91 | 3.09 | 3.09 | 2.16 | 3.71 | 0.33 |
| Parameter | EP23 | CP3 | EP34 | CP4 | EP45 | L | EP50 | d0s | d0m | D0s | D0m |
| Value | 0.51 | 0.32 | 0.51 | 0.02 | 0.35 | 3.34 | 0.89 | 2.26 | 4.04 | 3.06 | 4.83 |

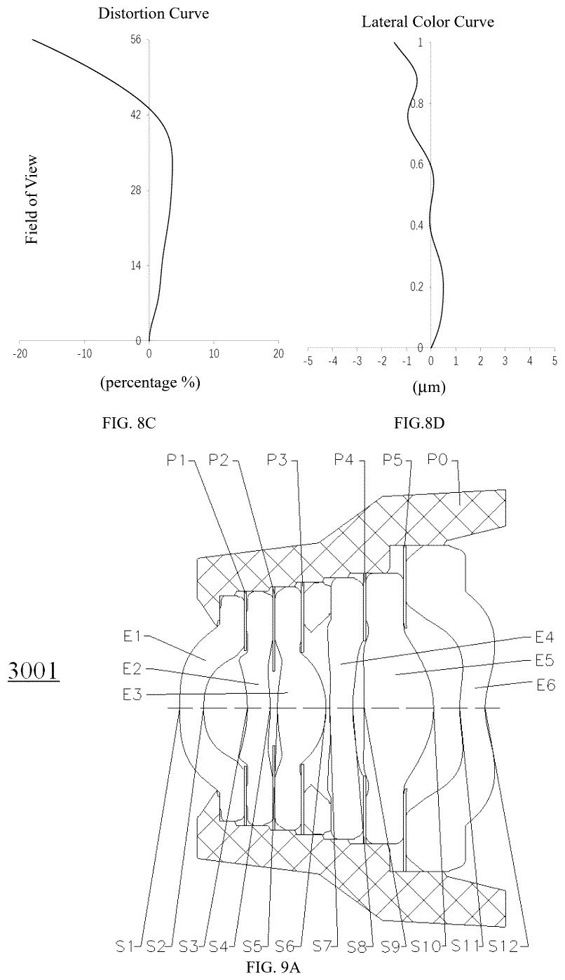

FIG. 8A shows the longitudinal aberration curves of the optical imaging lens assembly 2001 of Embodiment 3 and the optical imaging lens assembly 2002 of Embodiment 4. FIG. 8B shows the astigmatism curves of the optical imaging lens assembly 2001 of Embodiment 3 and the optical imaging lens assembly 2002 of Embodiment 4. FIG. 8C shows the distortion curves of the optical imaging lens assembly 2001 of Embodiment 3 and the optical imaging lens assembly 2002 of Embodiment 4. FIG. 8D shows the lateral color curves of the optical imaging lens assembly 2001 of Embodiment 3 and the optical imaging lens assembly 2002 of Embodiment 4. Based on FIGS. 8A to 8D, it can be seen that the optical imaging lens assembly 2001 and the optical imaging lens assembly 2002 according to Embodiment 3 and Embodiment 4 can achieve excellent imaging quality.

### Embodiment 5

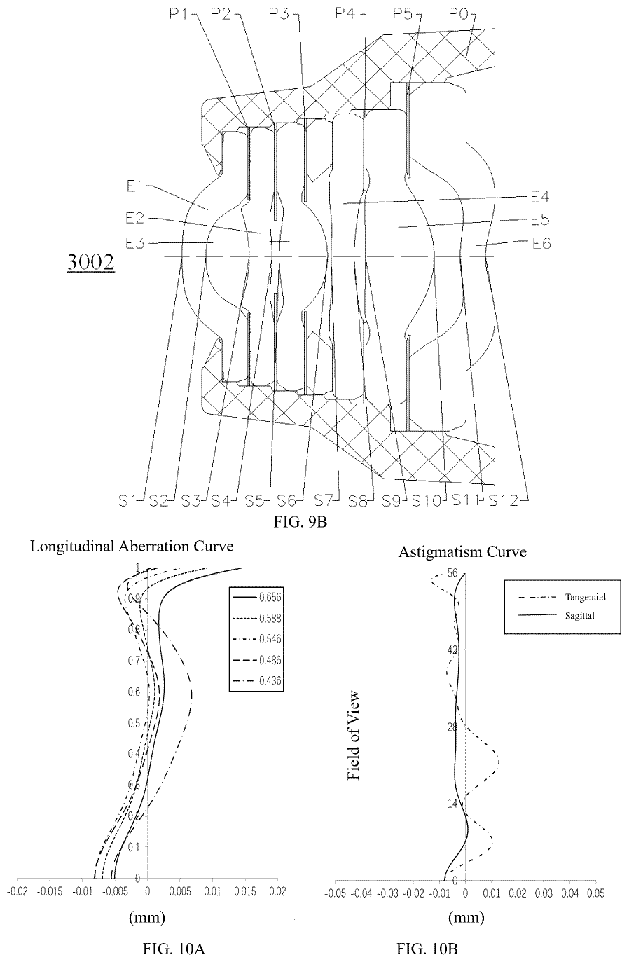

FIG. 9A shows a schematic structural diagram of an optical imaging lens assembly 3001 according to Embodiment 5 of the present application. As shown in FIG. 9A, the optical imaging lens assembly 3001 comprises a lens barrel P0, a lens group E1˜E6, and a supporting element group P1˜P5. The optical imaging lens assembly 3001 also comprises an aperture stop STO (not shown) located between the second lens and the third lens.

As shown in FIG. 9A, the lens group of the optical imaging lens assembly 3001 sequentially comprises, from the object side to the image side: a first lens E1, a second lens E2, a third lens E3, a fourth lens E4, a fifth lens E5, and a sixth lens E6. Among them, the object-side surface S1 of the first lens E1 is a convex surface, and the image-side surface S2 is a concave surface. The object-side surface S3 of the second lens E2 is a concave surface, and the image-side surface S4 is a convex surface. The object-side surface S5 of the third lens E3 is a convex surface, and the image-side surface S6 is a convex surface. The object-side surface S7 of the fourth lens E4 is a convex surface, and the image-side surface S8 is a concave surface. The object-side surface S9 of the fifth lens E5 is a concave surface, and the image-side surface S10 is a convex surface. The object-side surface S11 of the sixth lens E6 is a convex surface, and the image-side surface S12 is a concave surface. The optical imaging lens assembly 3001 also comprises a filter (not shown) for correcting color deviation, and the filter has an object-side surface S13 (not shown) and an image-side surface S14 (not shown). Light from the object sequentially passes through surfaces S1 to S14 and finally forms an image on the imaging surface S15 (not shown).

Table 10 shows the basic parameter table of the lens group of the optical imaging lens assembly 3001 of Embodiment 5, where the units for radius of curvature, thickness/distance, and effective focal length are all millimeters (mm). Tables 11-1 and 11-2 show the higher-order coefficients for each aspherical surface in Embodiment 5, where each aspherical surface profile can be defined by Formula (1) given in Embodiment 1 above.

TABLE 10

| | | | | Material | | |
|---|---|---|---|---|---|---|
| Surface | | Radius of | | Refractive | Abbe | Cone |
| number | Surface type | Curvature | Thickness/Distance | Index | number | coefficient |
| OBJ | spherical | Infinity | 400.0000 | | | |
| S1 | aspherical | 5.6592 | 0.2612 | 1.546 | 56.1 | −60.7718 |
| S2 | aspherical | 1.1052 | 0.4775 | | | 1.3852 |
| S3 | aspherical | −1.2816 | 0.2501 | 1.546 | 56.1 | −8.4039 |
| S4 | aspherical | −1.7509 | 0.0327 | | | −57.9700 |
| STO | spherical | Infinity | 0.0474 | | | |
| S5 | aspherical | 2.7500 | 0.5304 | 1.546 | 56.1 | 1.1041 |
| S6 | aspherical | −0.9254 | 0.0399 | | | 0.8581 |
| S7 | aspherical | 3.7970 | 0.2500 | 1.678 | 19.2 | −90.8516 |
| S8 | aspherical | 1.5923 | 0.1262 | | | −36.3059 |
| S9 | aspherical | −67.1651 | 0.7574 | 1.498 | 81.61 | 5.0000 |
| S10 | aspherical | −0.9973 | 0.2853 | | | −1.7181 |
| S11 | aspherical | 1.4020 | 0.2775 | 1.678 | 19.2 | −44.3162 |
| S12 | aspherical | 0.8394 | 0.2670 | | | −2.2629 |
| S13 | spherical | Infinity | 0.2100 | 1.52 | 64.2 | |
| S14 | spherical | Infinity | 0.3966 | | | |
| S15 | spherical | Infinity | | | | |

TABLE 11-1

| Surface number | A4 | A6 | A8 | A10 | A12 |
|---|---|---|---|---|---|
| S1 | 9.5915E−01 | −1.2586E+00 | 3.0425E−01 | 9.5096E+00 | −3.5382E+01 |
| S2 | 1.3757E+00 | 9.2033E−01 | −1.6914E+00 | −2.5918E+02 | 4.0093E+03 |
| S3 | 2.4161E−01 | −3.6997E+00 | 5.3829E+01 | −7.0764E+02 | 5.9246E+03 |
| S4 | 3.3353E−01 | 1.3957E+00 | −5.2589E+01 | 6.3589E+02 | −6.3030E+03 |
| S5 | 1.0211E+00 | −8.8108E+00 | 1.3706E+01 | 4.8012E+02 | −7.0371E+03 |
| S6 | −1.3675E−01 | −1.1550E+00 | 4.4400E+01 | −5.4879E+02 | 3.7164E+03 |
| S7 | −7.6178E−01 | 1.1734E+00 | 9.3034E+00 | −1.2747E+02 | 7.1276E+02 |
| S8 | 2.1892E−01 | −5.8539E+00 | 4.8585E+01 | −2.4268E+02 | 8.1021E+02 |
| S9 | −4.3311E−02 | −1.3935E+00 | 5.6726E+00 | 1.6157E+01 | −1.7596E+02 |
| S10 | −1.0058E−01 | 4.9991E−01 | −3.8583E+00 | 1.8624E+01 | −5.2639E+01 |
| S11 | 5.4000E−01 | −8.6748E+00 | 4.0090E+01 | −1.2140E+02 | 2.4754E+02 |
| S12 | −9.9208E−01 | 9.9494E−01 | 4.5248E−01 | −3.5993E+00 | 6.2963E+00 |

TABLE 11-2

| Sur- | | | | |
|---|---|---|---|---|
| face | | | | |
| num- | | | | |
| ber | A14 | A16 | A18 | A20 |
| S1 | 6.6455E+01 | −7.1092E+01 | 4.0369E+01 | −9.4346E+00 |
| S2 | −2.6283E+04 | 9.1607E+04 | −1.6444E+05 | 1.1665E+05 |
| S3 | −3.0855E+04 | 9.7756E+04 | −1.7224E+05 | 1.2924E+05 |
| S4 | 5.9453E+04 | −3.9165E+05 | 1.4233E+06 | −2.1037E+06 |
| S5 | 5.0231E+04 | −2.0418E+05 | 4.4879E+05 | −4.1264E+05 |
| S6 | −1.5239E+04 | 3.8013E+04 | −5.3319E+04 | 3.2489E+04 |
| S7 | −2.2201E+03 | 4.1094E+03 | −4.2518E+03 | 1.8946E+03 |
| S8 | −1.7908E+03 | 2.5513E+03 | −2.1458E+03 | 8.1132E+02 |
| S9 | 5.8387E+02 | −9.7473E+02 | 8.2114E+02 | −2.7725E+02 |
| S10 | 9.2496E+01 | −1.0104E+02 | 6.3652E+01 | −1.7464E+01 |
| S11 | −3.3417E+02 | 2.8310E+02 | −1.3534E+02 | 2.7811E+01 |
| S12 | −6.1101E+00 | 3.5129E+00 | −1.1155E+00 | 1.5071E−01 |

As shown in FIG. 9A, the optical imaging lens assembly 3001 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 12 shows the basic parameter table for the supporting elements and the lens barrel P0 of the optical imaging lens assembly 3001. All parameters in Table 12 are in millimeters (mm). These supporting elements can block excess external light from entering, allowing the lenses to be better supported by the lens barrel, and enhancing the structural stability of the optical imaging lens assembly 3001.

TABLE 12

| Parameter | d1s | d2s | d2m | d3s | D3s | d4m | D4s | D4m | d5s | D5m | EP12 |
|---|---|---|---|---|---|---|---|---|---|---|---|
| Value | 1.27 | 0.81 | 0.81 | 1.23 | 2.78 | 1.48 | 2.98 | 2.98 | 1.88 | 3.59 | 0.29 |
| Parameter | EP23 | CP3 | EP34 | CP4 | EP45 | L | EP50 | d0s | d0m | D0s | D0m |
| Value | 0.28 | 0.02 | 0.65 | 0.02 | 0.42 | 3.37 | 1.09 | 2.45 | 4.01 | 3.25 | 4.82 |

### Embodiment 6

FIG. 9B shows a schematic structural diagram of an optical imaging lens assembly 3002 according to Embodiment 6 of the present application. In this and the following embodiments, some descriptions similar to Embodiment 5 will be omitted for brevity.

As shown in FIG. 9B, the optical imaging lens assembly 3002 comprises a lens barrel P0, a lens group E1˜E6, and a supporting element group P1˜P5. The optical imaging lens assembly 3002 also comprises an aperture stop STO (not shown) located between the second lens and the third lens. The lens group of the optical imaging lens assembly 3002 is exactly the same as the lens group of the optical imaging lens assembly 3001 in Embodiment 5, and its basic parameters are detailed in Tables 10 to 11-2, which will not be repeated here.

As shown in FIG. 9B, the optical imaging lens assembly 3002 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 13 shows the basic parameter table for the supporting elements and the lens barrel P0 of the optical imaging lens assembly 3002. All parameters in Table 13 are in millimeters (mm). These supporting elements can block excess external light from entering, allowing the lenses to be better supported by the lens barrel, and enhancing the structural stability of the optical imaging lens assembly 3002.

TABLE 13

| Parameter | d1s | d2s | d2m | d3s | D3s | d4m | D4s | D4m | d5s | D5m | EP12 |
|---|---|---|---|---|---|---|---|---|---|---|---|
| Value | 1.26 | 0.8 | 0.8 | 1.23 | 3.11 | 1.48 | 3.31 | 3.31 | 1.88 | 3.92 | 0.27 |

| Parameter | EP23 | CP3 | EP34 | CP4 | EP45 | L | EP50 | d0s | d0m | D0s | D0m |
|---|---|---|---|---|---|---|---|---|---|---|---|
| Value | 0.31 | 0.02 | 0.63 | 0.02 | 0.45 | 3.22 | 0.94 | 2.52 | 4.28 | 3.41 | 5.13 |

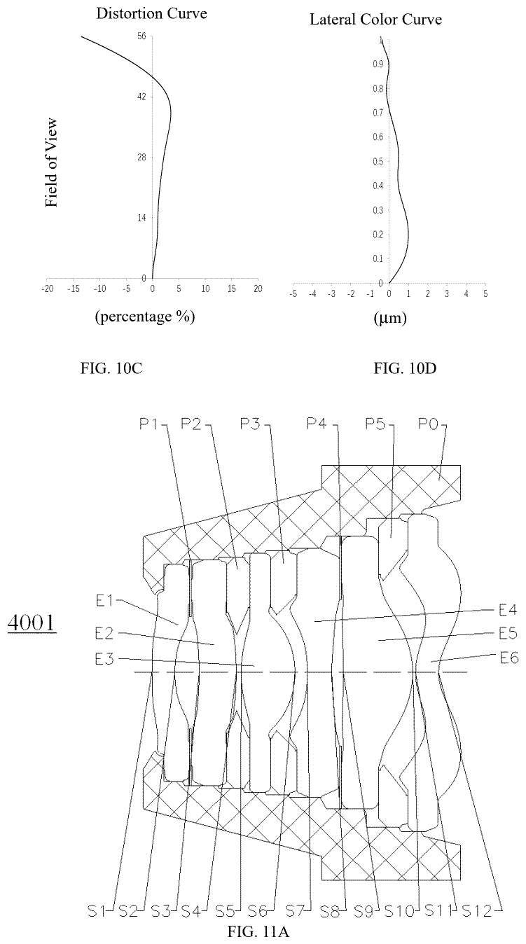

FIG. 10A shows the longitudinal aberration curves of the optical imaging lens assembly 3001 of Embodiment 5 and the optical imaging lens assembly 3002 of Embodiment 6. FIG. 10B shows the astigmatism curves of the optical imaging lens assembly 3001 of Embodiment 5 and the optical imaging lens assembly 3002 of Embodiment 6. FIG. 10C shows the distortion curves of the optical imaging lens assembly 3001 of Embodiment 5 and the optical imaging lens assembly 3002 of Embodiment 6. FIG. 10D shows the lateral color curves of the optical imaging lens assembly 3001 of Embodiment 5 and the optical imaging lens assembly 3002 of Embodiment 6. Based on FIGS. 10A to 10D, it can be seen that the optical imaging lens assembly 3001 and the optical imaging lens assembly 3002 according to Embodiment 5 and Embodiment 6 can achieve excellent imaging quality.

### Embodiment 7

FIG. 11A shows a schematic structural diagram of an optical imaging lens assembly 4001 according to Embodiment 7 of the present application. As shown in FIG. 11A, the optical imaging lens assembly 4001 comprises a lens barrel P0, a lens group E1˜E6, and a supporting element group P1˜P5. The optical imaging lens assembly 4001 also comprises an aperture stop STO (not shown) located between the second lens and the third lens.

As shown in FIG. 11A, the lens group of the optical imaging lens assembly 4001 sequentially comprises, from the object side to the image side: a first lens E1, a second lens E2, a third lens E3, a fourth lens E4, a fifth lens E5, and a sixth lens E6. Among them, the object-side surface S1 of the first lens E1 is a convex surface, and the image-side surface S2 is a concave surface. The object-side surface S3 of the second lens E2 is a concave surface, and the image-side surface S4 is a convex surface. The object-side surface S5 of the third lens E3 is a convex surface, and the image-side surface S6 is a convex surface. The object-side surface S7 of the fourth lens E4 is a concave surface, and the image-side surface S8 is a concave surface. The object-side surface S9 of the fifth lens E5 is a concave surface, and the image-side surface S10 is a convex surface. The object-side surface S11 of the sixth lens E6 is a convex surface, and the image-side surface S12 is a concave surface. The optical imaging lens assembly 4001 also comprises a filter (not shown) for correcting color deviation, and the filter has an object-side surface S13 (not shown) and an image-side surface S14 (not shown). Light from the object sequentially passes through surfaces S1 to S14 and finally forms an image on the imaging surface S15 (not shown).

Table 14 shows the basic parameter table of the lens group of the optical imaging lens assembly 4001 of Embodiment 7, where the units for radius of curvature, thickness/distance, and effective focal length are all millimeters (mm). Tables 15-1 and 15-2 show the higher-order coefficients for each aspherical surface in Embodiment 7, where each aspherical surface profile can be defined by Formula (1) given in Embodiment 1 above.

TABLE 14

| | | | | Material | | |
|---|---|---|---|---|---|---|
| | Surface | Radius of | | Refractive | Abbe | Cone |
| Surface number | type | Curvature | Thickness/Distance | Index | number | coefficient |
| OBJ | spherical | Infinity | 400.0000 | | | |
| S1 | aspherical | 8.8874 | 0.2500 | 1.536 | 55.7 | 5.0000 |
| S2 | aspherical | 1.4513 | 0.2637 | | | 0.0552 |
| S3 | aspherical | −3.1421 | 0.4034 | 1.645 | 23.5 | −96.9509 |
| S4 | aspherical | −2.8162 | −0.0068 | | | −20.6714 |
| STO | spherical | Infinity | 0.0592 | | | |
| S5 | aspherical | 1.4118 | 0.5849 | 1.546 | 56.1 | −0.8658 |
| S6 | aspherical | −0.9742 | 0.1347 | | | −0.0293 |
| S7 | aspherical | −2.2889 | 0.2649 | 1.645 | 23.5 | −2.4875 |
| S8 | aspherical | 1.8471 | 0.1260 | | | 2.3306 |
| S9 | aspherical | −6.1650 | 0.7554 | 1.591 | 61.16 | −29.0137 |
| S10 | aspherical | 0.9007 | 0.0300 | | | −0.8346 |
| S11 | aspherical | 0.7554 | 0.2511 | 1.536 | 55.7 | −5.9438 |
| S12 | aspherical | 0.5223 | 0.4000 | | | −2.1092 |
| S13 | spherical | Infinity | 0.2100 | 1.52 | 64.2 | |
| S14 | spherical | Infinity | 0.3780 | | | |
| S15 | spherical | Infinity | | | | |

TABLE 15-1

| Surface number | A4 | A6 | A8 | A10 | A12 |
|---|---|---|---|---|---|
| S1 | 6.6649E−01 | −1.9294E+00 | 4.6796E+00 | −1.3045E+01 | 2.1810E+01 |
| S2 | 1.2855E+00 | −2.8245E+00 | 6.2574E+00 | −1.4434E+01 | −1.9171E+02 |
| S3 | 3.8452E−02 | 5.6630E−01 | −1.4215E+01 | 9.5191E+01 | −4.7977E+02 |
| S4 | 2.8853E−01 | −4.2091E+00 | 3.3339E+01 | −2.1243E+02 | 1.0127E+03 |
| S5 | 1.9057E−01 | −3.7714E+00 | 2.0820E+01 | −7.3686E+01 | 1.1492E+02 |
| SE | −4.1164E−01 | 2.2697E+00 | −5.2087E+00 | −2.6585E+01 | 1.7566E+02 |
| S7 | −1.7658E+00 | 7.2735E+00 | −1.1784E+01 | −3.4031E+01 | 1.7298E+02 |
| S8 | −1.2434E+00 | 2.8489E+00 | −9.1654E−01 | −6.2239E+00 | 5.9188E+00 |
| S9 | 6.4491E−01 | −4.6643E+00 | 1.4788E+01 | −1.7607E+01 | −3.1827E+00 |
| S10 | 5.0539E−01 | −2.1847E+00 | 6.2723E+00 | −1.1749E+01 | 1.3794E+01 |
| S11 | 6.2633E−01 | −6.7927E+00 | 2.0876E+01 | −4.3513E+01 | 6.5040E+01 |
| S12 | −5.4548E−01 | −8.0431E−01 | 4.1585E+00 | −7.8958E+00 | 8.8900E+00 |

TABLE 15-2

| Surface | | | | |
|---|---|---|---|---|
| number | A14 | A16 | A18 | A20 |
| S1 | −1.8092E+01 | 5.9986E+00 | 0.0000E+00 | 0.0000E+00 |
| S2 | 7.4279E+02 | −7.1322E+02 | 0.0000E+00 | 0.0000E+00 |
| S3 | 1.2348E+03 | −1.1484E+03 | 0.0000E+00 | 0.0000E+00 |
| S4 | −2.8947E+03 | 3.9461E+03 | 0.0000E+00 | 0.0000E+00 |
| S5 | 1.8202E+00 | −1.0123E+02 | 0.0000E+00 | 0.0000E+00 |
| S6 | −3.9423E+02 | 3.3685E+02 | 0.0000E+00 | 0.0000E+00 |
| S7 | −2.3714E+02 | 1.0031E+02 | 0.0000E+00 | 0.0000E+00 |
| S8 | 6.1307E+00 | −7.9260E+00 | 0.0000E+00 | 0.0000E+00 |
| S9 | 2.4091E+01 | −1.5048E+01 | 0.0000E+00 | 0.0000E+00 |
| S10 | −6.8289E+00 | −9.1795E−01 | 1.3370E+00 | 0.0000E+00 |
| S11 | −6.6185E+01 | 4.2788E+01 | −1.5732E+01 | 2.4949E+00 |
| S12 | −6.3383E+00 | 2.8012E+00 | −7.0008E−01 | 7.5655E−02 |

As shown in FIG. 11A, the optical imaging lens assembly 4001 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 16 shows the basic parameter table for the supporting elements and the lens barrel P0 of the optical imaging lens assembly 4001. All parameters in Table 16 are in millimeters (mm). These supporting elements can block excess external light from entering, allowing the lenses to be better supported by the lens barrel, and enhancing the structural stability of the optical imaging lens assembly 4001.

TABLE 16

| Parameter | d1s | d2s | d2m | d3s | D3s | d4m | D4s | D4m | d5s | D5m | EP12 |
|---|---|---|---|---|---|---|---|---|---|---|---|
| Value | 1.25 | 1.33 | 1.43 | 1.44 | 2.49 | 1.61 | 3 | 3 | 2.15 | 3.31 | 0.39 |
| Parameter | EP23 | CP3 | EP34 | CP4 | EP45 | L | EP50 | d0s | d0m | D0s | D0m |
| Value | 0.23 | 0.28 | 0.47 | 0.02 | 0.4 | 3.53 | 0.57 | 2.15 | 3.79 | 2.92 | 4.56 |

### Embodiment 8

FIG. 11B shows a schematic structural diagram of an optical imaging lens assembly 4002 according to Embodiment 8 of the present application. In this and the following embodiments, for brevity, descriptions similar to Embodiment 7 will be omitted.

As shown in FIG. 11B, the optical imaging lens assembly 4002 comprises a lens barrel P0, a lens group E1˜E6, and a supporting element group P1˜P5. The optical imaging lens assembly 4002 also comprises an aperture stop STO (not shown) located between the second lens and the third lens. The lens group of the optical imaging lens assembly 4002 is exactly the same as the lens group of the optical imaging lens assembly 4001 in Embodiment 7, and its basic parameters are detailed in Tables 14 to 15-2, which will not be repeated here.

As shown in FIG. 11B, the optical imaging lens assembly 4002 also comprises five supporting elements: a first supporting element P1, a second supporting element P2, a third supporting element P3, a fourth supporting element P4, and a fifth supporting element P5. Among these, the first supporting element P1 is placed on the image side of the first lens E1 and is in contact with the image-side surface of the first lens E1; the second supporting element P2 is placed on the image side of the second lens E2 and is in contact with the image-side surface of the second lens E2; the third supporting element P3 is placed on the image side of the third lens E3 and is in contact with the image-side surface of the third lens E3; the fourth supporting element P4 is placed on the image side of the fourth lens E4 and is in contact with the image-side surface of the fourth lens E4; and the fifth supporting element P5 is placed on the image side of the fifth lens E5 and is in contact with the image-side surface of the fifth lens E5. Furthermore, the first supporting element P1, the second supporting element P2, the third supporting element P3, the fourth supporting element P4, and the fifth supporting element P5 are in contact with the inner wall of the lens barrel P0. Table 17 shows the basic parameter table for the supporting elements and the lens barrel P0 of the optical imaging lens assembly 4002. All parameters in Table 17 are in millimeters (mm). These supporting elements can block excess external light from entering, allowing the lenses to be better supported by the lens barrel, and enhancing the structural stability of the optical imaging lens assembly 4002.

TABLE 17

| Parameter | d1s | d2s | d2m | d3s | D3s | d4m | D4s | D4m | d5s | D5m | EP12 |
|---|---|---|---|---|---|---|---|---|---|---|---|
| Value | 1.23 | 1.33 | 1.53 | 1.41 | 2.57 | 1.61 | 3.27 | 3.27 | 2.28 | 3.61 | 0.36 |
| Parameter | EP23 | CP3 | EP34 | CP4 | EP45 | L | EP50 | d0s | d0m | D0s | D0m |
| Value | 0.22 | 0.28 | 0.48 | 0.02 | 0.4 | 3.64 | 0.78 | 2.32 | 4.09 | 3.43 | 4.87 |

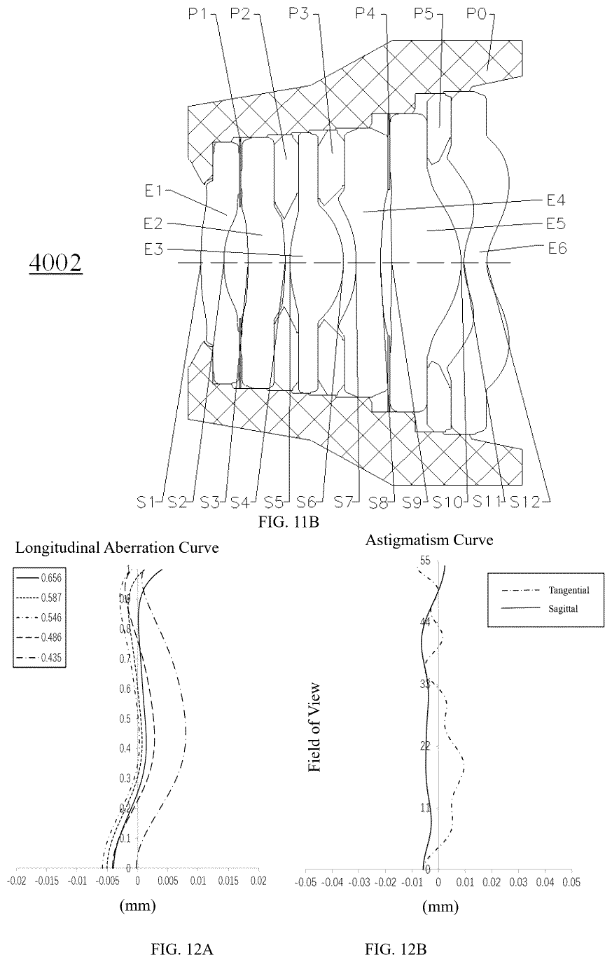

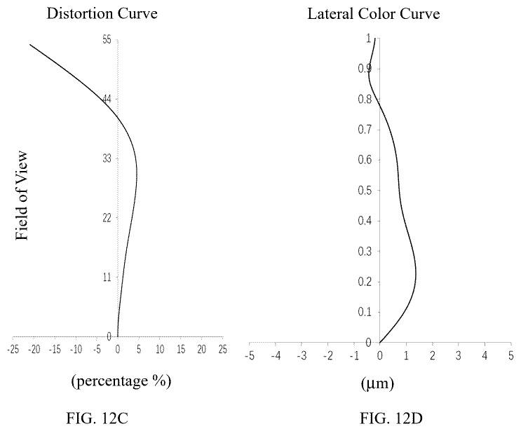

FIG. 12A shows the longitudinal aberration curves of the optical imaging lens assembly 4001 of Embodiment 7 and the optical imaging lens assembly 4002 of Embodiment 8. FIG. 12B shows the astigmatism curves of the optical imaging lens assembly 4001 of Embodiment 7 and the optical imaging lens assembly 4002 of Embodiment 8. FIG. 12C shows the distortion curves of the optical imaging lens assembly 4001 of Embodiment 7 and the optical imaging lens assembly 4002 of Embodiment 8. FIG. 12D shows the lateral color curves of the optical imaging lens assembly 4001 of Embodiment 7 and the optical imaging lens assembly 4002 of Embodiment 8. Based on FIGS. 12A to 12D, it can be seen that the optical imaging lens assembly 4001 and the optical imaging lens assembly 4002 according to Embodiment 7 and Embodiment 8 can achieve excellent imaging quality.

Table 18 shows the values for the maximum field of view FOV (°), the F-number Fno, the effective focal length f (mm) of the optical imaging lens assemblies, the effective focal lengths f1˜f6 (mm) of the first to sixth lenses, the axial distance SAG31 (mm) between the intersection point of the object-side surface of the third lens and the optical axis and the effective radius vertex of the object-side surface of the third lens, the axial distance SAG32 (mm) between the intersection point of the image-side surface of the third lens and the optical axis and the effective radius vertex of the image-side surface of the third lens, the axial distance SAG51 (mm) between the intersection point of the object-side surface of the fifth lens and the optical axis and the effective radius vertex of the object-side surface of the fifth lens, the axial distance SAG52 (mm) between the intersection point of the image-side surface of the fifth lens and the optical axis and the effective radius vertex of the image-side surface of the fifth lens, the edge thickness ET1 (mm) of the first lens in the effective optical region, and the edge thickness ET4 (mm) of the fourth lens in the effective optical region in Embodiments 1 to 8.

TABLE 18

| Parameter | 1 | 2 | 3 | 4 | 5 | 6 | 7 | 8 |
|---|---|---|---|---|---|---|---|---|
| FOV(°) | 113.08 | 113.08 | 112.06 | 112.06 | 111.85 | 111.85 | 108.25 | 108.25 |
| Fno | 2.20 | 2.20 | 2.20 | 2.20 | 2.19 | 2.19 | 2.19 | 2.19 |
| f(mm) | 1.35 | 1.35 | 1.38 | 1.38 | 1.31 | 1.31 | 1.53 | 1.53 |
| f1(mm) | −3.16 | −3.16 | −3.69 | −3.69 | −2.57 | −2.57 | −3.27 | −3.27 |
| f2(mm) | 373.41 | 373.41 | −6.88 | −6.88 | −10.78 | −10.78 | 28.28 | 28.28 |
| f3(mm) | 1.28 | 1.28 | 1.14 | 1.14 | 1.34 | 1.34 | 1.15 | 1.15 |
| f4(mm) | −2.13 | −2.13 | −2.80 | −2.80 | −4.24 | −4.24 | −1.54 | −1.54 |
| f5(mm) | 1.67 | 1.67 | 1.55 | 1.55 | 2.02 | 2.02 | 1.69 | 1.69 |
| f6(mm) | −4.16 | −4.16 | −2.51 | −2.51 | −3.86 | −3.86 | −5.06 | −5.06 |
| SAG31(mm) | 0.03 | 0.03 | 0.03 | 0.03 | 0.04 | 0.04 | 0.09 | 0.09 |
| SAG32(mm) | −0.29 | −0.29 | −0.24 | −0.24 | −0.25 | −0.25 | −0.26 | −0.26 |
| SAG51(mm) | 0.10 | 0.10 | 0.08 | 0.08 | 0.02 | 0.02 | 0.00 | 0.00 |
| SAG52(mm) | −0.35 | −0.35 | −0.39 | −0.39 | −0.32 | −0.32 | −0.35 | −0.35 |
| ET1(mm) | 0.25 | 0.25 | 0.21 | 0.21 | 0.22 | 0.22 | 0.34 | 0.34 |
| ET4(mm) | 0.48 | 0.48 | 0.44 | 0.44 | 0.36 | 0.36 | 0.52 | 0.52 |

In summary, the optical imaging lens assemblies of Embodiments 1 to 8 satisfy the relationships shown in Table 19.

TABLE 19

| | Embodiment | | | | | | | |
|---|---|---|---|---|---|---|---|---|
| Condition | 1 | 2 | 3 | 4 | 5 | 6 | 7 | 8 |
| CT3/CT4 | 2.86 | 2.86 | 3.18 | 3.18 | 2.12 | 2.12 | 2.21 | 2.21 |
| CT5/T45 | 7.10 | 7.10 | 2.65 | 2.65 | 6.00 | 6.00 | 5.99 | 5.99 |
| (CT3 + CT5)/L | 2.38 | 2.48 | 2.21 | 2.24 | 2.62 | 2.50 | 2.64 | 2.72 |
| CT5/SAG52 | −1.88 | −1.88 | −1.78 | −1.78 | −2.36 | −2.36 | −2.14 | −2.14 |
| EP45/CT5 | 0.53 | 0.48 | 0.49 | 0.51 | 0.55 | 0.60 | 0.53 | 0.53 |
| CT1/ET1 | 1.00 | 1.00 | 1.30 | 1.30 | 1.18 | 1.18 | 0.74 | 0.74 |
| EP01/(CT1 + T12) | 0.45 | 1.21 | 0.63 | 0.64 | 1.02 | 0.99 | 0.78 | 0.86 |
| (d5s − d2m)/Tr5r10 | 0.42 | 0.42 | 0.68 | 0.70 | 0.63 | 0.63 | 0.39 | 0.41 |
| R6/f3 | −1.04 | −1.04 | −0.95 | −0.95 | −0.69 | −0.69 | −0.84 | −0.84 |
| SAG32/SAG31 | −8.97 | −8.97 | −9.42 | −9.42 | −5.66 | −5.66 | −2.90 | −2.90 |
| CT3/EP23 | 1.83 | 1.88 | 1.48 | 1.54 | 1.92 | 1.74 | 2.57 | 2.71 |
| f3/f | 0.95 | 0.95 | 0.83 | 0.83 | 1.02 | 1.02 | 0.76 | 0.76 |
| d3s/D3s | 0.72 | 0.69 | 0.71 | 0.68 | 0.44 | 0.40 | 0.58 | 0.55 |
| SAG51/CT5 | 0.15 | 0.15 | 0.11 | 0.11 | 0.03 | 0.03 | 0.00 | 0.00 |
| d4m/f5 | 1.17 | 1.15 | 1.24 | 1.23 | 0.73 | 0.73 | 0.95 | 0.95 |
| (D4s − | 0.95 | 0.95 | 0.48 | 0.64 | 0.48 | 0.48 | 0.98 | 1.33 |
| D3s)/(T34 + CT4 + T45) | | | | | | | | |
| d5s/T56 | 65.84 | 66.65 | 71.25 | 72.17 | 6.59 | 6.60 | 71.77 | 76.07 |
| (D5m − D4m)/EP45 | 1.77 | 1.95 | 2.09 | 1.76 | 1.47 | 1.35 | 0.77 | 0.85 |
| (D5m − D4m)/(D0m − d0m) | 0.66 | 0.90 | 0.77 | 0.78 | 0.76 | 0.72 | 0.40 | 0.44 |
| R3/f | −1.77 | −1.77 | −1.21 | −1.21 | −0.98 | −0.98 | −2.05 | −2.05 |
| R3/EP12 | −6.60 | −6.60 | −4.97 | −5.06 | −4.43 | −4.69 | −8.10 | −8.79 |
| d2s/T23 | 42.27 | 43.11 | 37.08 | 37.08 | 10.17 | 10.00 | 25.35 | 25.40 |
| (d0s − d1s)/CT1 | 6.03 | 6.41 | 4.27 | 4.35 | 4.51 | 4.84 | 3.61 | 4.37 |
| tan(FOV/2) | 1.51 | 1.51 | 1.48 | 1.48 | 1.48 | 1.48 | 1.38 | 1.38 |
| f1/f | −2.34 | −2.34 | −2.68 | −2.68 | −1.96 | −1.96 | −2.14 | −2.14 |
| (D0m − D0s)/TD | 0.55 | 0.49 | 0.53 | 0.53 | 0.47 | 0.52 | 0.53 | 0.46 |
| L/TD | 1.02 | 1.06 | 1.02 | 1.03 | 1.04 | 0.99 | 1.09 | 1.13 |
| (d0m − d5m)/EP50m | 2.26 | 2.12 | 2.03 | 2.11 | 1.95 | 2.55 | 1.91 | 1.75 |
| ET4/(CP3 + EP34 + CP4) | 0.62 | 0.61 | 0.54 | 0.52 | 0.52 | 0.54 | 0.68 | 0.67 |
| TD/f | 2.39 | 2.39 | 2.43 | 2.43 | 2.55 | 2.55 | 2.04 | 2.04 |
| CT5/CT6 | 2.27 | 2.27 | 2.50 | 2.50 | 2.73 | 2.73 | 3.01 | 3.01 |
| (d0m − d5s)/CT6 | 6.30 | 6.78 | 6.39 | 6.74 | 7.69 | 8.65 | 6.53 | 7.21 |
| T34/CT4 | 0.45 | 0.45 | 0.12 | 0.12 | 0.16 | 0.16 | 0.51 | 0.51 |

The present application also provides an imaging device, whose electronic photosensitive element can be a Charge-Coupled Device (CCD) or a Complementary Metal-Oxide-Semiconductor (CMOS) element. The imaging device can be a standalone imaging device such as a digital camera, or an imaging module integrated into mobile electronic devices such as mobile phones. This imaging device is equipped with the optical imaging lens assembly described above.

The above descriptions are merely preferred embodiments of the present application and explanations of the technical principles employed. Those skilled in the art should understand that the scope of disclosure involved in the present application is not limited to technical solutions formed by specific combinations of the above technical features, but should also cover other technical solutions formed by arbitrary combinations of the above technical features or their equivalent features without departing from the inventive concept. For example, technical solutions formed by mutual replacement of the above features with technical features disclosed in this application (but not limited to) having similar functions.

What is claimed is:

1. An optical imaging lens assembly, comprising a lens barrel, and a lens group and a supporting element group disposed in the lens barrel, wherein,
the lens group sequentially comprises, along an optical axis from an object side to an image side: a first lens having negative refractive power, its object-side surface being a convex surface and its image-side surface being a concave surface; a second lens having refractive power, its object-side surface being a concave surface and its image-side surface being a convex surface;
a third lens having positive refractive power, its object-side surface being a convex surface and its image-side surface being a convex surface; a fourth lens having negative refractive power, its image-side surface being a concave surface; a fifth lens having positive refractive power, its image-side surface being a convex surface; and a sixth lens having negative refractive power, its object-side surface being a convex surface and its image-side surface being a concave surface;
the supporting element group comprises a fifth supporting element disposed on the image side of the fifth lens and in contact with the image-side surface of the fifth lens; and
the optical imaging lens assembly satisfies: 2.25<CT5/CT6<3.05; 6.25<(d0m−d5s)/CT6<8.7, wherein, CT5 is the central thickness of the fifth lens on the optical axis, CT6 is the central thickness of the sixth lens on the optical axis, d0m is the inner diameter of the image-side end surface of the lens barrel, and d5s is the inner diameter of the object-side surface of the fifth supporting element.

2. The optical imaging lens assembly according to claim 1, wherein the optical imaging lens assembly satisfies:
$$2.1 < CT 3 / CT 4 < 3.2 ; 2.2 < ( CT 3 + CT 5 ) / L < 2.75 ,$$
wherein, CT3 is the central thickness of the third lens on the optical axis, CT4 is the central thickness of the fourth lens on the optical axis, CT5 is the central thickness of the fifth lens on the optical axis, and L is the distance along the optical axis from the object-side end surface to the image-side end surface of the lens barrel.

3. The optical imaging lens assembly according to claim 1, wherein the optical imaging lens assembly satisfies:
$$0.45 < ( D 0 m - D 0 s ) / TD < 0.6 ; 0.95 < L / TD < 1.15 ,$$
wherein, D0m is the outer diameter of the image-side end surface of the lens barrel, D0s is the outer diameter of the object-side end surface of the lens barrel, TD is the distance along the optical axis from the object-side surface of the first lens to the image-side surface of the sixth lens, and L is the distance along the optical axis from the object-side end surface to the image-side end surface of the lens barrel.

4. The optical imaging lens assembly according to claim 1, wherein the optical imaging lens assembly satisfies:
$$1. 7 < ( d 0 m - d 5 m ) / EP 50 m < 2.6 ,$$
wherein, d0m is the inner diameter of the image-side end surface of the lens barrel, d5m is the inner diameter of the object-side surface of the fifth supporting element, and EP50m is the distance along the optical axis from the fifth supporting element to the image-side end surface of the lens barrel.

5. The optical imaging lens assembly according to claim 1, wherein the supporting element group further comprises a fourth supporting element disposed on the image side of the fourth lens and in contact with the image-side surface of the fourth lens, and the optical imaging lens assembly satisfies:
$$- 2.4 < CT 5 / SAG 52 < - 1.73 ; 0.45 < EP 45 / CT 5 < 0.65 ,$$
wherein, CT5 is the central thickness of the fifth lens on the optical axis, SAG52 is the axial distance between the intersection point of the image-side surface of the fifth lens and the optical axis and the effective radius vertex of the image-side surface of the fifth lens, and EP45 is the distance along the optical axis from the image-side surface of the fourth supporting element to the object-side surface of the fifth supporting element.

6. The optical imaging lens assembly according to claim 1, wherein the distance along the optical axis from the image-side surface of the first lens to the object-side surface of the second lens is greater than the distance along the optical axis between any other two adjacent lenses, the supporting element group further comprises a first supporting element disposed on the image side of the first lens and in contact with the image-side surface of the first lens, and the optical imaging lens assembly satisfies:
$$0.7 < CT 1 / ET 1 \leq 1.3 ; 0.4 < EP 01 / ( CT 1 + T 12 ) < 1.25 ,$$
wherein, CT1 is the central thickness of the first lens on the optical axis, ET1 is the edge thickness of the first lens in the effective optical region, EP01 is the distance along the optical axis from the object-side end surface of the lens barrel to the object-side surface of the first supporting element, and T12 is the distance along the optical axis from the image-side surface of the first lens to the object-side surface of the second lens.

7. The optical imaging lens assembly according to claim 1, wherein the supporting element group further comprises a second supporting element disposed on the image side of the second lens and in contact with the image-side surface of the second lens and the inner wall of the lens barrel, and the optical imaging lens assembly satisfies:
$$0.35 < ( d 5 s - d 2 m ) / Tr 5 r 10 \leq 0.70 ,$$
wherein, d5s is the inner diameter of the object-side surface of the fifth supporting element, d2m is the inner diameter of the image-side surface of the second supporting element, and Tr5r10 is the distance along the optical axis from the object-side surface of the third lens to the image-side surface of the fifth lens.

8. The optical imaging lens assembly according to claim 1, wherein the supporting element group further comprises a second supporting element disposed on the image side of the second lens and in contact with the image-side surface of the second lens and the inner wall of the lens barrel, and a third supporting element disposed on the image side of the third lens and in contact with the image-side surface of the third lens, and the optical imaging lens assembly satisfies:
$$- 1.1 < R 6 / f 3 < - 0.65 ; - 9.47 < SAG 32 / SAG 31 < - 2 \text{.85} ; 1.45 < CT 3 / EP 23 < 2.75 ,$$
wherein, R6 is the radius of curvature of the image-side surface of the third lens, f3 is the effective focal length of the third lens, SAG32 is the axial distance between the intersection point of the image-side surface of the third lens and the optical axis and the effective radius vertex of the image-side surface of the third lens, SAG31 is the axial distance between the intersection point of the object-side surface of the third lens and the optical axis and the effective radius vertex of the object-side surface of the third lens, CT3 is the central thickness of the third lens on the optical axis, and EP23 is the distance along the optical axis from the image-side surface of the second supporting element to the object-side surface of the third supporting element.

9. The optical imaging lens assembly according to claim 1, wherein the absolute value of the effective focal length of the third lens is less than the absolute value of the effective focal length of other lenses, the supporting element group further comprises a third supporting element disposed on the image side of the third lens and in contact with the image-side surface of the third lens, and the optical imaging lens assembly satisfies:
$$0.75 < f 3 / f < 1.05 ; 0.35 < d 3 s / D 3 s < 0.75 ,$$
wherein, f3 is the effective focal length of the third lens, f is the effective focal length of the optical imaging lens assembly, d3s is the inner diameter of the object-side surface of the third supporting element, and D3s is the outer diameter of the object-side surface of the third supporting element.

10. The optical imaging lens assembly according to claim 1, wherein the supporting element group further comprises a fourth supporting element disposed on the image side of the fourth lens and in contact with the image-side surface of the fourth lens, and the optical imaging lens assembly satisfies:
$$0 \leq SAG 51 / CT 5 < 0.2 ; 0.7 < d 4 m / f 5 < 1.3 ,$$
wherein, SAG51 is the axial distance between the intersection point of the object-side surface of the fifth lens and the optical axis and the effective radius vertex of the object-side surface of the fifth lens, CT5 is the central thickness of the fifth lens on the optical axis, d4m is the inner diameter of the image-side surface of the fourth supporting element, and f5 is the effective focal length of the fifth lens.

11. The optical imaging lens assembly according to claim 1, wherein the supporting element group further comprises a third supporting element disposed on the image side of the third lens and in contact with the image-side surface of the third lens, and a fourth supporting element disposed on the image side of the fourth lens and in contact with the image-side surface of the fourth lens, and the optical imaging lens assembly satisfies:
$$0.1 < T 34 / CT 4 < 0.55 ; 0.45 < ( D 4 s - D 3 s ) / ( T 34 + CT 4 + T 45 ) < 1.38 ,$$
wherein, T34 is the distance along the optical axis from the image-side surface of the third lens to the object-side surface of the fourth lens, CT4 is the central thickness of the fourth lens on the optical axis, T45 is the distance along the optical axis from the image-side surface of the fourth lens to the object-side surface of the fifth lens, D4s is the outer diameter of the object-side surface of the fourth supporting element, and D3s is the outer diameter of the object-side surface of the third supporting element.

12. The optical imaging lens assembly according to claim 1, wherein the supporting element group further comprises a fourth supporting element disposed on the image side of the fourth lens and in contact with the image-side surface of the fourth lens, the fourth supporting element and the fifth supporting element are in contact with the inner wall of the lens barrel, and the inner wall of the lens barrel has a transverse step between the locations where the fourth supporting element and the fifth supporting element contact the inner wall of the lens barrel, and the optical imaging lens assembly satisfies:
$$6.54 < d 5 s / T 56 < 76.1 ; 0.75 < ( D 5 m - D 4 m ) / EP 45 < 2.1 ,$$
wherein, d5s is the inner diameter of the object-side surface of the fifth supporting element, T56 is the distance along the optical axis from the image-side surface of the fifth lens to the object-side surface of the sixth lens, D5m is the outer diameter of the image-side surface of the fifth supporting element, D4m is the outer diameter of the image-side surface of the fourth supporting element, and EP45 is the distance along the optical axis from the image-side surface of the fourth supporting element to the object-side surface of the fifth supporting element.

13. The optical imaging lens assembly according to claim 12, wherein the optical imaging lens assembly satisfies:
$$0.4 \leq ( D 5 m - D 4 m ) / ( D 0 m - d 0 m ) < 0.95 ,$$
wherein, D5m is the outer diameter of the image-side surface of the fifth supporting element, D4m is the outer diameter of the image-side surface of the fourth supporting element, D0m is the outer diameter of the image-side end surface of the lens barrel, and d0m is the inner diameter of the image-side end surface of the lens barrel.

14. The optical imaging lens assembly according to claim 1, wherein the supporting element group further comprises a first supporting element disposed on the image side of the first lens and in contact with the image-side surface of the first lens, and the optical imaging lens assembly satisfies:
$$1. 33 < tan ( FOV / 2 ) < 1.56 ; - 2.7 < fl / f < - 1.9 ; 3.6 < ( d 0 s - d 1 s ) / CT 1 < 6.45 ,$$
wherein, FOV is the maximum field angle of the optical imaging lens assembly, f1 is the effective focal length of the first lens, f is the effective focal length of the optical imaging lens assembly, dos is the inner diameter of the object-side end surface of the lens barrel, d1s is the inner diameter of the object-side surface of the first supporting element, and CT1 is the central thickness of the first lens on the optical axis.

15. The optical imaging lens assembly according to claim 1, wherein the supporting element group further comprises a third supporting element disposed on the image side of the third lens and in contact with the image-side surface of the third lens, and a fourth supporting element disposed on the image side of the fourth lens and in contact with the image-side surface of the fourth lens, and the optical imaging lens assembly satisfies:
at least 2 lenses have a refractive index greater than 1.6, wherein the refractive index of the fourth lens is greater than 1.6; and
$$0.5 < ET 4 / ( CP 3 + EP 34 + CP 4 ) < 0.7 ,$$
wherein, ET4 is the edge thickness of the fourth lens in the effective optical region, CP3 is the distance along the optical axis from the object-side surface to the image-side surface of the third supporting element, EP34 is the distance along the optical axis from the image-side surface of the third supporting element to the object-side surface of the fourth supporting element, and CP4 is the distance along the optical axis from the object-side surface to the image-side surface of the fourth supporting element.
